(19) United States
(12) Patent Application Publication
(10) Pub. No.: US 2026/0023375 A1
(43) Pub. Date: Jan. 22, 2026

(54) METHODS AND SYSTEMS FOR DECENTRALIZED STEADY STATE ERROR CANCELLATION IN LARGE SCALE, INTERCONNECTED SYSTEMS

(71) Applicant: KING FAHD UNIVERSITY OF PETROLEUM AND MINERALS, Dhahran (SA)

(72) Inventors: Ahmed MASOUD, Dhahran (SA); Mahmoud KASSAS, Dhahran (SA)

(73) Assignee: KING FAHD UNIVERSITY OF PETROLEUM AND MINERALS, Dhahran (SA)

(21) Appl. No.: 19/333,049

(22) Filed: Sep. 18, 2025

Related U.S. Application Data
(63) Continuation of application No. 18/793,064, filed on Aug. 2, 2024, now abandoned.

(30) Foreign Application Priority Data
Jul. 22, 2024 (SA) 1020244075

(51) Int. Cl. G05B 23/02

(52) U.S. Cl. CPC G05B 23/0256

(57) ABSTRACT

A decentralized controller and methods for steady-state error cancellation in a plant system with multiple components comprises an error control loop for each component, where each error control loop includes steady-state control signals and plant output signals. Each error control loop receives a set point value and plant output signals and generates error signals. The error signals are amplified to produce amplified error control signals. A trigger circuit, connected to output of the multiplier, detects steady-state events in the error signals and generates trigger pulses accordingly. A sample and hold circuit receives the trigger pulses and the negative steady-state control signals and generates a steady-state error cancellation signal which is then injected back into the error control loop to mitigate steady-state errors. The sample and hold circuit also generates a reset signal which clears an integrator in the trigger circuit to prevent integrator wind-up.

### BACKGROUND

### Technical Field

The present disclosure is directed to methods and system for maintaining stability of an industrial plant, and more particularly, to decentralized steady state error cancellation in large scale industrial plants.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Industrial plants are typically massive, interconnected, and nonlinear systems that operate under tightly regulated and predictable conditions. These plants are designed to be stable with acceptable dynamic behavior. A challenge faced by such industrial plants is the varying and unpredictable load on their components. These loads can cause deviations from the desired set points assigned to each component, leading to steady-state errors.

Industrial plants may encompass a system having a wide array of interconnected machinery and processes implemented to achieve specific production goals. Each component within the plant is assigned a set point, a predetermined value representing the optimal operating condition for that particular element. Maintaining these set points is required for the overall efficiency and stability of the plant. However, the interconnected nature of the system means that a change in load or operating condition in one part of the plant can have ripple effects throughout the entire system.

The varying and unpredictable loads in industrial plants can stem from several sources. External factors, such as fluctuations in power supply, changes in raw material quality, and environmental conditions can all impact the load on plant components. Additionally, internal factors, such as wear and tear of machinery, operational shifts, and production demands can lead to variations in load. The unpredictable loads challenge the ability of the control systems to maintain the desired set points consistently.

When the load on a component deviates from its set point, the system must respond to correct the error. This process, known as error correction or compensation, is essential to bring the component back to its optimal operating condition. However, frequent, and significant deviations can overburden the control systems, leading to inefficiencies and potential instabilities. Over time, these steady-state errors can accumulate, causing long-term deviations that may affect the overall performance and safety of the plant.

Furthermore, the nonlinear nature of industrial systems adds complexity to the control and stabilization processes. Nonlinearity is the relationship between input and output which is not proportional, making it difficult to predict how changes in one part of the system will affect the whole system. Such nonlinearity can cause control systems to react unpredictably, sometimes exacerbating the very errors they are designed to correct. Extensive research has been conducted to overcome the challenges associated with maintaining the stability and efficient performance of industrial plants.

In one example, a proportional integral (PI) controller is configured for the cancellation of steady-state error in industrial systems. The PI controller operates in a decentralized mode, utilizing only the state information of the device on which it is installed, without requiring communication with other components of the plant to acquire their states. The PI controller operates in a manner that is almost blind to the dynamics of the component. Despite the widespread use and various advantages, the PI controller has limitations. The PI controller can interfere with system stability and transient behavior, potentially causing a stable system to become unstable. Tuning of the PI controller must be done heuristically and carefully using established procedures [See: G. J. Silva, A. Datta and S. P. Bhattacharyya “PID Controllers for Time-Delay Systems,” Chapter 1, published by Birkhauser Boston, 2005]. Moreover, the PI controllers are sensitive to low-frequency noise, leading to the wind-up problem that requires special measures to mitigate its effects on the system [See: K. J. Astrom and L. Rundqwist, “Integrator Windup and How to Avoid It,” 1989 American Control Conference, Pittsburgh, PA, USA, 1989, pp. 1693-1698].

In another example, industrial error tracking controllers from various control aspects useful for typical industrial Multiple-Input Multiple-Output (MIMO) systems have been implemented. The industrial error tracking controllers are based on performance analysis and comparison of control techniques, commonly used in the process industry, emphasizing various issues that a control scheme must address to be accepted by the industry. The aspects considered for the performance analysis and the comparison include the amount of information needed about the model of the controlled process or system, the complexity of controller parameter tuning and the need for re-tuning during operation, decentralization, quality of the control signal and tracking performance, ability to cope with disturbances and robustness against model uncertainties, sensitivity to dead-time delays, handling of actuator nonlinearities, such as saturation and hysteresis, sensing and processing requirements, quality of the control signal in terms of dynamic range and smoothness, and controller-specific problems.

In the present disclosure, three control mechanisms commonly used in industry have been analyzed for each of the above-defined traits. These control schemes include a proportional-integral-derivative (PID) control, a model predictive control (MPC), and a sliding mode control (SMC).

Control techniques, such as the MPC and the SMC, are significantly influenced by the amount of information concerning the process or system model to be controlled. Accurately modeling the real-time processes is often initially challenging. Even with a full model, the cost of sensing and computation is intrinsically tied to this issue, making it highly significant for industries where cost-effectiveness is paramount. MPCs are favored in industrial applications due to their performance; however, as a model-based control method, they require a complete system model upfront. Researchers typically either use an already developed benchmark process model [See: Haitao Huang, James B Riggs, Comparison of PI and MPC for control of a gas recovery unit, Journal of Process Control, Volume 12, Issue 1, 2002, Pages 163-173, ISSN 0959-1524, https://doi.org/10.1016/S0959-1524(01)00004-X; Y. A. Sha'aban, B. Lennox, D. Laurí, PID versus MPC Performance for SISO Dead-time Dominant Processes*, IFAC Proceedings Volumes, Volume 46, Issue 32, 2013, Pages 241-246] or apply system identification techniques to create a system model before implementing MPC [See: M. Geetha, R. Naveen, J. Jerome and V. S. Kumar, “Real-time implementation and performance analysis of state estimation based model predictive controller for CSTR plant,” 2013 Fourth International Conference on Computing, Communications and Networking Tec], since accurate process system models are rarely available. To enhance performance, the future behavior of the system should be predicted based on current states and ideally disturbance information. Such requirements necessitate sophisticated state estimators [See: Vadim Utkin, Hoon Lee, Chattering Problem In Sliding Mode Control Systems, IFAC Proceedings Volumes, Volume 39, Issue 5, 2006, Page 1; M. Geetha, R. Naveen, J. Jerome and V S. Kumar, “Real-time implementation and performance analysis of state estimation based model predictive controller for CSTR plant,” 2013 Fourth International Conference on Computing, Communications and Networking Tec], which further increase the knowledge needed for MPC deployment.

PID controllers, unlike other control methods, can function adequately with only output feedback and do not require knowledge of the complete system model. However, to fine-tune a PID controller for optimized performance, a system model is required to define the objective function of the optimization technique. Sliding Mode Control (SMC) depends on the system model to accurately develop the control law for all sliding surfaces [See: Soheil Ghabraei, Hamed Moradi, Gholamreza Vossoughi, Multivariable robust adaptive sliding mode control of an industrial boiler-turbine in the presence of modeling imprecisions and external disturbances: A comparison with type-I servo controller, ISA Tran; S. Janardhanan “Sliding Mode Control—An Introduction”, https://slideplayer.com/slide/152369931. Thus, except for manually tuned PID controllers, working effectively with minimal system information is challenging.

Tuning controller parameters is often a labor-intensive task, which further explains the prevalence of PID control in industries, as PID tuning is simpler compared to other controllers. PID remains a well-established control technique, with extensive research over the past 30 to 40 years focused on PID tuning, including for multi-loop industrial systems. In an example, a 1991 study [See: J. T. Tanttu, F. Cameron and H. Lisitzin, “Experimental comparison of some multivariable PI controller tuning methods,” Proceedings IECON '91: 1991 International Conference on Industrial Electronics, Control and Instrumentation, Kobe, Japan, 1991, pp. 181] experimentally compared four multivariable PI controller tuning methods using a laboratory-scaled paper machine head-box model. Recently, evolutionary optimization methods have been utilized for MIMO PID tuning. The colonial competitive algorithm (CCA) and the genetic algorithm (GA) were used to tune a tri-loop PID for an evaporator system, resulting in better set point tracking than the commonly used Zeigler-Nichols method. Similarly, [See: S. Saha, S. Das, A. Pakhira, S. Mukherjee and I. Pan, “Comparative studies on decentralized multiloop PID controller design using evolutionary algorithms,” 2012 Students Conference on Engineering and Systems, Allahabad, India, 2012, pp. 1-6 employed three algorithms includes a genetic algorithm, an evolutionary strategy, and a cultural algorithm to optimize gains for a decentralized PID controller, with a comparative analysis carried out on four benchmark 2×2 multivariable processes through simulations.

In industrial robotics, motion profile tracking is common. It was demonstrated in [See: M. S. Tsoeu and M. Esmail, “Unconstrained MPC and PID evaluation for motion profile tracking applications,” IEEE Africon '11, Victoria Falls, Zambia, 2011, pp. 1-6 that a PID controller tuned using Pareto optimality can perform well in such applications. Self-tuning PID algorithms have also gained traction recently. Techniques such as just-in-time learning (JITL) have been applied to nonlinear MIMO systems on benchmark processes, showing promising results in terms of asymptotic convergence of tracking errors and disturbance rejection [See: Y. Ohnishi, T. Yamamoto and S. L. Shah, “Design of a multivariable self-tuning PID controller with an internal model structure,” Proceedings of the IEEE 2000 Adaptive Systems for Signal Processing, Communications, and Control Symposium (Cat. No. 00EX373)]. Therefore, an optimally tuned PID controller generally requires system model information to formulate the optimization problem.

For more complex controllers such as MPCs, the scenarios are even more demanding [See: M S. Tsoeu and M Esmail, “Unconstrained MPC and PID evaluation for motion profile tracking applications,” IEEE Africon '11, Victoria Falls, Zambia, 2011, pp. 1-6, doi: 10.1109/AFRCON.2011.6072037], particularly with MIMO nonlinear processes. With large-dimensional parameters, translating the cost function to achieve desired behavior becomes exceptionally difficult. For instance, Huang [See: Haitao Huang, James B Riggs, Comparison of PI and MPC for control of a gas recovery unit, Journal of Process Control, Volume 12, Issue 1, 2002, Pages 163-173] avoided tuning due to these large dimensions. The numerous parameters in commercial MPCs, which are often interdependent, make parameter tuning an arduous task for control engineers [See: Alan Hugo “Limitations of Model Predictive Controllers” January 2000, Hydrocarbon Processing 79(1):83-88]. Moreover, there needs to be a balance between performance and robustness [See: Vadim Utkin, Hoon Lee, Chattering Problem In Sliding Mode Control Systems, IFAC Proceedings Volumes, Volume 39, Issue 5, 2006, Page 1].

The necessity for re-tuning controllers arises in certain instances, typically with sliding mode controllers. Self-tuning adaptive methods are frequently utilized to optimize SMC performance, reduce chattering, and address unbounded uncertainties [See: F. Baklouti, S. Aloui, O. Pagès, A. Chaari, A. El Hajjaji “Improved fault-tolerant fuzzy sliding-mode control for a class of MIMO nonlinear systems” 14th International Conference on Sciences and Techniques of Automatic Control and Computer Engineering, STA]. A widely recognized method in nonlinear and MIMO systems is a self-tuning fuzzy SMC [See: F. Baklouti, S. Aloui, O. Pagès, A. Chaari, A. El Hajjaji “Improved fault-tolerant fuzzy sliding-mode control for a class of MIMO nonlinear systems” 14th International Conference on Sciences and Techniques of Automatic Control and Computer Engineering, STA; CihanKarakuzu “Parameter Tuning Of Fuzzy Sliding Mode Controller Using Particle Swarm Optimization” International Journal of Innovative Computing, Information and Control, Volume 6, Number 10, pp 4755-4770, October 2010; Chen, Hung-Yi; Huang, Shiuh-Jer “Adaptive fuzzy sliding-mode control for the Ti6Al4V laser alloying process” International Journal of Advanced Manufacturing Technology, v 24, n 9-10, p 667-674, November 2004]. Parameters for fuzzy logic controllers are often tuned through trial and error [See: CihanKarakuzu “Parameter Tuning Of Fuzzy Sliding Mode Controller Using Particle Swarm Optimization” International Journal of Innovative Computing, Information and Control, Volume 6, Number 10, pp 4755-4770, October 2010], although some studies use optimization techniques for this purpose. An article [See: CihanKarakuzu “Parameter Tuning Of Fuzzy Sliding Mode Controller Using Particle Swarm Optimization” International Journal of Innovative Computing, Information and Control, Volume 6, Number 10, pp 4755-4770, October 2010] implements the heuristic technique particle swarm optimization (PSO) to tune SMC on various chaotic systems. Other auto-tuning techniques for SMC of nonlinear systems based on Lyapunov stability have also been presented [See: Hsueh, Yao-Chu; Su, Shun-Feng; Wang, Wen-June “Self-tuning sliding mode controller design for a class of nonlinear control systems” Conference Proceedings—IEEE International Conference on Systems, Man and Cybernetics, p 2337-2342, 2008; Zhao, Zhan-Shan; Zhang, Jing; Sun, Lian-Kun; Ding, Gang “Higher order sliding mode control with self-tuning law for a class of uncertain nonlinear systems” KongzhiyuJuece/Control and Decision, v 26, n 8, p 1277-1280, August 2011]. Clearly, tuning SMC demands substantial effort and system knowledge.

The industrial process control systems are multivariable, or multiple-input-multiple-output (MIMO) systems [See: R. Viknesh, N. Sivakumaran, J. S. Chandra, T. K. Radhakrishnan, “A Critical Study of Decentralized Controllers for a Multivariable System”, Chemical Engineering & Technology Volume 27, Issue 8p. 880-889], meaning these systems have fewer manipulated variables than controlled variables. In multivariable process control, each output can be influenced by multiple inputs, leading to loop interaction and other complications [See: S. Saha, S. Das, A. Pakhira, S. Mukherjee and I. Pan, “Comparative studies on decentralized multiloop PID controller design using evolutionary algorithms,” 2012 Students Conference on Engineering and Systems, Allahabad, India, 2012, pp. 1-6]. However, decentralized multi-loop PID controllers can manage these issues, which significantly contributes to the widespread use of PID controllers in industrial process control.

The primary drawback of MPCs is their traditional centralized control approach. Centralized controllers struggle with large-scale systems composed of interacting subsystems, as the global optimal control problem becomes massive and complex. Decentralized MPCs have been introduced, modeling large-scale processes as several subsystems, each with its own MPC. A single high-level controller oversees communication among subsystems and maintains a global model of the entire system [See: Bemporad, A., Barcelli, D. (2010). Decentralized Model Predictive Control. In: Bemporad, A., Heemels, M., Johansson, M. (eds) Networked Control Systems. Lecture Notes in Control and Information Sciences, vol 406. Springer, London. https://doi.org/10.1007/]. Despite these advancements, decentralized MPC theory need further research and advancements for real industrial application [See: Bemporad, A., Barcelli, D. (2010). Decentralized Model Predictive Control. In: Bemporad, A., Heemels, M., Johansson, M. (eds) Networked Control Systems. Lecture Notes in Control and Information Sciences, vol 406. Springer, London. https://doi.org/10.1007/].

Sliding mode control can also be decentralized. A decentralized tracking method for interconnected nonlinear systems was proposed using variable structure control in 1988 but did not gain significant traction [See: Gregory P. Matthews, Raymond A. DeCarlo, “Decentralized tracking for a class of interconnected nonlinear systems using variable structure control”, Automatica, Volume 24, Issue 2, 1988, Pages 187-193]. A more popular method was proposed for multivariable chemical process control [See: Chen, Chyi-Tsong; Peng, Shih-Tien “Design of a sliding mode control system for chemical processes” Journal of Process Control, v 15, n 5, p 515-530, August 2005]. However, practical multivariable processes often have loop interactions, complicating SMC design compared to PID. These interactions need to be modelled as disturbances or managed with a decoupling technique [See: Chen, Chyi-Tsong; Peng, Shih-Tien “Design of a sliding mode control system for chemical processes” Journal of Process Control, v 15, n 5, p 515-530, August 2005]. Thus, using SMC as a decentralized controller remains complex.

PID controllers can be used in a decoupled, nearly blind manner, although performance compromises in terms of smoothness and response time are often necessary. Unlike MPC, PID does not account for dynamic process models, constraints, future system behavior, or nonlinearity as SMC does, limiting its competitiveness. Comparative studies [See: Finn Haugen “MPC vs PID”, Presentation at NI Day, 22. April 2010 Lillestrøm, Norway. https://dokumen.tips/documents/ni-day-mpc-pid-april-2010-telemark-university-of-measurement-noise-through-controller.html?page=1; M. Geetha, R. Naveen, J. Jerome and V. S. Kumar, “Real-time implementation and performance analysis of state estimation based model predictive controller for CSTR plant,” 2013 Fourth International Conference on Computing, Communications and Networking Tec; Haitao Huang, James B Riggs, Comparison of PI and MPC for control of a gas recovery unit, Journal of Process Control, Volume 12, Issue 1, 2002, Pages 163-173] indicate PID is inferior to MPC in various industrial systems (e.g., air heater temperature control [See: Finn Haugen “MPC vs PID”, Presentation at NI Day, 22. April 2010 Lillestrøm, Norway. https.//dokumen.tips/documents/ni-day-mpc-pid-april-2010-telemark-university-of-measurement-noise-through-controller.html?page=], CSTR level [See: M. Geetha, R. Naveen, J. Jerome and V S. Kumar, “Real-time implementation and performance analysis of state estimation based model predictive controller for CSTR plant,” 2013 Fourth International Conference on Computing, Communications and Networking Tec], industrial gas recovery [See: Haitao Huang, James B Riggs, Comparison of PI and MPC for control of a gas recovery unit, Journal of Process Control, Volume 12, Issue 1, 2002, Pages 163-173]) based on error tracking measures, such as settling time, overshoots, and steady-state error. In industrial robot manipulators, where precise motion tracking is crucial, a decentralized PID controller fails to achieve the desired steady-state error performance compared to a sliding mode controller [See: G. Legnani and A. Visioli, “Experimental valuation of decentralized controllers for industrial robot manipulators,” Proceedings of the 1998 IEEE International Conference on Control Applications (Cat. No. 98CH36104), Trieste, Italy, 1998, pp. 567-571 vol. 1,]. These performance issues can lead to significant economic losses, pushing industries to adopt more complex control methods [See: Haitao Huang, James B Riggs, “Comparison of PI and MPC for control of a gas recovery unit”, Journal of Process Control, Volume 12, Issue 1, 2002, Pages 163-173].

Disturbance rejection and noise insensitivity are essential for set point tracking controllers. Industry-standard controllers have their own advantages and disadvantages. A PID controller, relying on output feedback, operates blindly and is generally insensitive to slight parameter variations. However, in specific cases, such as the one in [See: M. Geetha, R. Naveen, J. Jerome and V S. Kumar, “Real-time implementation and performance analysis of state estimation based model predictive controller for CSTR plant”, 2013 Fourth International Conference on Computing, Communications and Networking Tec], where a perturbation briefly increases the outflow in the CSTR level process, the PID controller requires prolonged recovery to steady state compared to an MPC controller. The MPC, being heavily model-dependent, is less robust to model uncertainties, as shown experimentally for an air heater temperature control system [See: Finn Haugen “MPC vs PID”, Presentation at NI Day, 22. April 2010 Lillestrøm, Norway. https://dokumen.tips/documents/ni-day-mpc-pid-april-2010-telemark-university-of-measurement-noise-through-controller.html?page=], where increased loop time delay causes oscillating MPC output. Similarly, a nonlinear MPC performs poorly with unmodeled gains [See: Vadim Utkin, Hoon Lee, “Chattering Problem In Sliding Mode Control Systems”, IFAC Proceedings Volumes, Volume 39, Issue 5, 2006, Page 1]. Commercial MPCs often assume all disturbances are step-like, which is inaccurate for many disturbances. For example, with long drifting disturbances, MPCs underestimate and inadequately respond. A solution is to replace the step disturbance model with a low-order transfer function [See: Lundström, P., Lee, J. H., Morari, M., and Skogestad, S., Limitations of Dynamic Matrix Control, Comp. & Chem. Eng., 19, 4, 1995], which theoretically tightens control but may be sensitive to model mismatch and noise, requiring disturbance response knowledge [See: Alan Hugo “Limitations of Model Predictive Controllers” January 2000, Hydrocarbon Processing 79(1):83-88].

In view of aforementioned techniques, sliding mode control techniques may differ. When a system achieves sliding mode control, original system parameters are irrelevant, and the system is governed by stable sliding surface parameters [See: K. D. Young, V. L Utkin and U. Ozguner, “A control engineer's guide to sliding mode control,” in IEEE Transactions on Control Systems Technology, vol. 7, no. 3, pp. 328-342, May 1999], ensuring robustness against model uncertainties. The sliding surface dynamics are independent of the input channel, giving SMC intrinsic disturbance rejection [See: K. D. Young, V. I. Utkin and U. Ozguner, “A control engineer's guide to sliding mode control,” in IEEE Transactions on Control Systems Technology, vol. 7, no. 3, pp. 328-342, May 1999; S. Janardhanan “Sliding Mode Control—An Introduction”, https://slideplayer.com/slide/15236993/].

Industrial systems experience time delays between control signal application and system impact, known as ‘dead time’ or ‘transportation lag’. PID controllers perform poorly with such dead time dominant processes. Optimal PID performance degrades significantly with time delays [See: Y. A. Sha'aban, B. Lennox, D. Laurí, PID versus MPC Performance for SISO Dead-time Dominant Processes, IFAC Proceedings Volumes, Volume 46, Issue 32, 2013, Pages 241-246]. The literature shows extensive concern for PID time-delay compensation, with popular techniques discussed in a survey [See: Aidan O'Dwyer “PID compensation of time delayed processes 1998-2002: a survey” Proceedings of the Irish Signals and Systems Conference, Dublin, Ireland, June 2000, pp. 5-12].

Thus, MPC and SMC controllers have been preferred for processes with significant dead time. Industries often approximate processes as first-order-plus-dead-time (FOPDT) models for simplicity. Due to their predictive nature, MPCs naturally compensate for delays, as shown in various references [See: Y. A. Sha'aban, B. Lennox, D. Laurí, PID versus MPC Performance for SISO Dead-time Dominant Processes*, IFAC Proceedings Volumes, Volume 46, Issue 32, 2013, Pages 241-246]. A study by Utz et al. [See: T. Utz, V. Hagenmeyer, B. Mahn and M. Zeitz, “Nonlinear model predictive and flatness-based two-degree-of-freedom control design: A comparative evaluation in view of industrial application,” 2006 IEEE Conference on Computer Aided Control System Design, 2006 IEEE International Conference on Control Applications, 2006 IEEE International Symposium on Intelligent Control, Munich, Germany, 2006, pp. 217-223] controlling a Klatt-Engell reactor model with the nonlinear MPC reported robustness against unmodeled measurement delays exceeding 1000 seconds. However, achieving this robustness often requires separate dead time compensation schemes, such as a model correction filter using a Smith predictor [See: Santos, Tito L. M.; Limon, Daniel; Normey-Rico, Julio E.; Alamo, Teodoro “On the explicit dead-time compensation for robust model predictive control” Journal of Process Control, v 22, n 1, p 236-246, January 2012; Wojsznis, Willy; Gudaz, John; Blevins, Terry; Mehta, Ashish “Practical approach to tuning MPC” ISA Transactions, v 42, n 1, p 149-162, January 2003], or augmenting the dead-time delay in the system model, which can lead to increasing model order linearly with dead-time length [See: Santos, Tito L. M.; Limon, Daniel; Normey-Rico, Julio E.; Alamo, Teodoro “On the explicit dead-time compensation for robust model predictive control” Journal of Process Control, v 22, n 1, p 236-246, January 2012]. Explicit dead-time compensation methods have been proposed and tested on systems like the quadruple tank and laboratory heater processes [See: Santos, Tito L. M.; Limon, Daniel; Normey-Rico, Julio E.; Alamo, Teodoro “On the explicit dead-time compensation for robust model predictive control” Journal of Process Control, v 22, n 1, p 236-246, January 2012].

Sliding mode control has also been studied extensively for industrial processes with significant dead time. Simple SMC design often fails to manage dead time delays, necessitating predictive SMC or combinations with a prediction mechanism, such as the Smith predictor. [See: Sha, D. H; Bajic, V. B. “Discrete sliding mode control for processes with long dead-time” Iranian Journal of Electrical and Computer Engineering, v 7, n 1, p 47-53, 2008]. Examples include time-delay chemical processes controlled with SMC and delay-ahead predictor [See: Chen, Chyi-Tsong; Peng, Shih-Tien “Design of a sliding mode control system for chemical processes” Journal of Process Control, v 15, n 5, p 515-530, August 2005], a CSTR benchmark system with sliding mode predictive control (SMPC) [See: García-Gabín, Winston; Normey-Rico, Julio E.; Camacho, Eduardo F. “Sliding mode predictive control of a delayed CSTR” IFAC Proceedings Volumes (IFAC-PapersOnline), v 6, n PART 1, p 246-251, 2006, 6th IFAC Workshop on Time Delay Systems, TDS 2006], and the combination of SMC and generalized predictive controller (GPC) for fluid temperature control in a steam generator [See: Tahami, F.; Nademi, H. “A non-linear controller design for the evaporator of a heat recovery steam generator” Proceedings of the Institution of Mechanical Engineers, Part A: Journal of Power and Energy, v 223, n 5, p 535-541, Aug. 1, 2009]. Therefore, achieving robust control with advanced schemes like MPC and SMC in dead time dominant processes is a complex challenge.

In process control, nonlinearities due to actuators appear frequently in control loops, necessitating that all effective industrial controllers manage these nonlinearities. A primary issue observed here is actuator saturation, which is particularly problematic when integral action is present in the control loop, leading to what is known as the integral windup issue. Another prevalent problem in control valves, electrical actuators, or piezoelectric actuators is hysteresis. While PID controllers are effective for linear systems, they do not adequately address complex nonlinearities, such as hysteresis [See: M. Hamdan and Zhiqiang Gao, “A novel PID controller for pneumatic proportional valves with hysteresis,” Conference Record of the 2000 IEEE Industry Applications Conference. Thirty-Fifth IAS Annual Meeting and World Conference on Industrial Applications].

A commonly used industrial solution to mitigate this problem is the implementation of a feedforward loop with PID, which linearly approximates the hysteresis characteristics. However, this solution merely estimates the nonlinearity and does not guarantee effective compensation under all conditions [See: M. Hamdan and Zhiqiang Gao, “A novel PID controller for pneumatic proportional valves with hysteresis,” Conference Record of the 2000 IEEE Industry Applications Conference. Thirty-Fifth IAS Annual Meeting and World Conference on Industrial Applications]. A more robust strategy involves modeling the hysteresis characteristics directly. A prevalent model based on a preisach theory has been utilized in various studies. One such study is [See: Tang, Hui; Li, Yangmin “Feedforward nonlinear PID control of a novel micromanipulator using Preisach hysteresis compensator” Robotics and Computer-Integrated Manufacturing, v 34, p 124-132, August 2015], where the position of a micromanipulator is controlled using piezoelectric actuators and a developed hysteresis model in feedforward.

Other advanced control schemes, such as MPC and SMC, adopt similar approaches for modeling and compensating for hysteresis. For more sophisticated techniques, reference can be made to chapter 5 of the book by [See: Lei Liu, Yi Yang “Modeling and Precision Control of Systems with Hysteresis” Chapter 5: Control Approaches for system with Hysteresis, p. 88-99, 2016]. However, these hysteresis compensation methods involve complex mathematics (e.g., double integrals) and require additional sensing, leading to increased complexity and cost [See: Tang, Hui; Li, Yangmin “Feedforward nonlinear PID control of a novel micromanipulator using Preisach hysteresis compensator” Robotics and Computer-Integrated Manufacturing, v 34, p 124-132, August 2015].

Furthermore, practical considerations for industrial controllers, including the preferred simplicity and reduced computation needs, explain the widespread adoption of PID controllers. Compared to controllers like MPC and SMC, PID controllers are inherently less computationally intensive, even when deployed for complex decentralized control of multivariable systems [See: M. S. Tsoeu and M. Esmail, “Unconstrained MPC and PID evaluation for motion profile tracking applications,” IEEE Africon '11, Victoria Falls, Zambia, 2011, pp. 1-6, doi: 10.1109/AFRCON.2011.6072037]. For instance, it has been documented in [See: Vadim Utkin, Hoon Lee, CHATTERING PROBLEM IN SLIDING MODE CONTROL SYSTEMS, IFAC Proceedings Volumes, Volume 39, Issue 5, 2006, Page 1, ISSN 1474-6670, ISBN 9783902661067, https://doi.org/10.3182/20060607-3-IT-3902.00003] that MPC requires solving a compute-intensive optimization task in each operation cycle, which often necessitates an external computer because it cannot be performed by typical DCS. The use of complex estimators further increases the numerical demand on the controller.

Regarding sensing requirements, there is typically a balance between computational complexity and sensing needs. PID controllers, functioning as output feedback controllers, require only the system output for manual tuning. However, optimal performance necessitates sensing the system states. Thus, designers can opt either to utilize sensors (for measuring system variables) or to increase the computational complexity (by estimating required states). Modern controllers, in general, require more comprehensive system knowledge, thereby enhancing the demand for sensing and processing capabilities.

Integral windup poses a significant challenge in control systems, especially for PID controllers. Understanding this issue necessitates an understanding of operation of the integrator. The integrator functions as memory within the controller, generating output based on past errors to maintain the process variable at the set point. The integrator accumulates the error after each cycle for usage in subsequent cycles. In cases of actuator saturation, the error remains constant, leading to continuous integration and resulting in an uncontrolled buildup of the integral term. If the system output eventually attains the set point and the error becomes zero, the integrator will use the reverse error to diminish the accumulated sum. During this “wind-down” process, the controller output remains saturated, causing significant delays in the system response [See: G. J. Silva, A. Datta and S. P. Bhattacharyya “PID Controllers for Time-Delay Systems,” Chapter 1, ISBN 0-8176-4266-8, Birkhauser Boston, 2005; A. Miryala, K. Scarlett, Z. Zell and B. Kountz “PID Downsides & Solutions,” University of Michigan Chemical Engineering Process Dynamics and Controls Open Textbook, 2007]. This slow recovery can only be resolved by addressing the windup issue via either a reference reduction or an enlargement of the actuator limits; otherwise, control loss is a risk.

Several causes of integral windup have been identified, including large and abrupt set point variations, significantly large disturbance, and equipment malfunctions. Various anti-windup schemes have been proposed to address challenges as discussed above. Such anti-windup schemes include set point limitation, back calculation and tracking, conditional integration, and saturation modeling. Among these, back calculation and tracking is the commonly employed method [See: K. J. Astrom and L. Rundqwist, “Integrator Windup and How to Avoid It,” 1989 American Control Conference, Pittsburgh, PA, USA, 1989, pp. 1693-1698, doi: 10.23919/ACC.1989.4790464; Markaroglu, H., M. Guzelkaya, I. Eksin, and E. Yesil, “Tracking Time Adjustment in Back Calculation Anti-windup Scheme,” 20th Eur. Conf Model. and Simul., Bonn, Germany (2006); K. J. Åström “Control System Design,” Chapter 6, Karl Johan Astrom, Department of Mechanical & Environmental Engineering University of California Santa Barbara, 2002 Karl Johan Åström].

US20200341442A1 describes an adaptive anti-windup protection for a control system with cascaded inner and outer control loops. The control system entails an outer error loop for receiving feedback from the plant output and an inner error loop for receiving feedback from an actuator. Windup and saturation are addressed through outer loop anti-windup request limits.

U.S. Pat. No. 4,872,104 describes an apparatus and method for eliminating integrator windup in control systems featuring a control input, a feedback signal, and an actuator that can saturate due to dynamic nonlinearities such as slew rate limits. This apparatus includes circuitry to determine rate of change in the integrator output, comparing it to predetermined maximum allowable rates. If these rates are exceeded, a comparator generates a compensation error signal, which, when combined with the usual error signal, reduces rate of change in output of the integrator. The feedback loop incorporates a rate of change detector and a comparator to generate an error signal component added to the error signal.

Each of the aforementioned existing techniques suffers from one or more drawbacks hindering their adoption. The existing techniques fail to fully address the complexities and variabilities in industrial process control systems. These methods lack comprehensive solutions for high pass filtering, non-linearity detection, error duration integration, and precise timing for reset pulses, leading to inadequate mitigation of integrator windup, instability, and suboptimal performance.

There is, accordingly, a need for improved anti-windup mechanisms offering precise control and stability in complex, variable industrial environments. There is a need to provide robust control mechanisms that account for nonlinearities and dynamic changes in system conditions, crucial for maintaining desired set points and ensuring efficient operation in interconnected, nonlinear industrial plants.

### SUMMARY

In an exemplary embodiment, a decentralized controller for steady state error cancellation in a plant system having N components comprises an error control loop for each component i of the N components, wherein each error control loop includes steady state control signals uᵢ(t) and plant output signals Xᵢ(t), wherein each error control loop includes a first multiplier configured to receive a set point value Rᵢ and the plant output signals Xᵢ(t), multiply the set point value Rᵢ by a negative value of the plant output signals Xᵢ(t) and generate error signals eᵢ(t); an amplifier connected to an output terminal of the first multiplier, wherein the amplifier is configured to amplify the error signals eᵢ(t) by a gain Kᵢ and generate amplified error control signals Kᵢ·uᵢ(t); a trigger circuit connected to the output terminal of the first multiplier, wherein the trigger circuit is configured to receive the error signals eᵢ(t); detect a steady state event of the error signals and generate a trigger pulse gᵢ(t) based on detecting the steady state event; and a sample and hold circuit configured to receive the trigger pulse gᵢ(t) and negative values of the steady state control signals uᵢ(t), generate a steady state error cancellation signal Z(t)ᵢ and inject the steady state error cancellation signal Z(t)ᵢ into the error control loop.

In another exemplary embodiment, a method for cancelling steady state error in a plant system having N components comprises establishing an error control loop for each component i of the N components, wherein each error control loop includes steady state control signals uᵢ(t) and plant output signals Xᵢ(t); performing steady state error cancellation in each error control loop by receiving, by a first multiplier, a set point value Rᵢ and the plant output signals Xᵢ(t), multiplying the set point value Rᵢ by a negative value of the plant output signals Xᵢ(t) and generating error signals eᵢ(t); amplifying, with an amplifier connected to an output terminal of the first multiplier, the error signals eᵢ(t) by a gain Kᵢ and generating amplified error control signals Kᵢ·uᵢ(t); receiving, by a trigger circuit connected to the output terminal of the first multiplier, the error signals eᵢ(t); detecting, by the trigger circuit, a steady state event of the error signals; generating by the trigger circuit, a trigger pulse gᵢ(t) based on detecting the steady state event; and receiving, by a sample and hold circuit connected to the trigger circuit, the trigger pulse gᵢ(t) and negative values of the steady state control signals uᵢ(t); generating, by the sample and hold circuit, a steady state error cancellation signal Z(t)_{I}; and injecting, by the sample and hold circuit, the steady state error cancellation signal Z(t)ᵢ into the error control loop.

In another exemplary embodiment, a method for performing steady state error cancellation in a plant system having N components comprises establishing an error control loop for each component i of the N components, wherein each error control loop includes steady state control signals uᵢ(t) and plant output signals Xᵢ(t); performing steady state error cancellation in each error control loop by receiving, by a first multiplier, a set point value Rᵢ and the plant output signals Xᵢ(t), multiplying the set point value Rᵢ by a negative value of the plant output signals Xᵢ(t) and generating error signals eᵢ(t); amplifying, with an amplifier connected to an output terminal of the first multiplier, the error signals eᵢ(t) by a gain Kᵢ and generating an amplified error control signals Kᵢ·uᵢ(t); receiving, by a trigger circuit connected to the output terminal of the first multiplier, the error signals eᵢ(t); detecting, by the trigger circuit, a steady state event of the error signals; generating by the trigger circuit, a trigger pulse gᵢ(t) based on detecting the steady state event; and receiving, by a sample and hold circuit connected to the trigger circuit, the trigger pulse gᵢ(t) and negative values of the steady state control signals uᵢ(t); generating, by the sample and hold circuit, a steady state error cancellation signal Z(t)_{I}; injecting, by the sample and hold circuit, the steady state error cancellation signal Z(t)ᵢ into the error control loop; summing, by an adder connected to the amplifier and the sample and hold circuit, the amplified error signals Kᵢ·uᵢ(t) with the steady state error cancellation signal Z(t)ᵢ and generating the steady state control signals uᵢ(t); detecting the steady state event of the error signals by the trigger circuit by integrating, with an integrator, transformed signals S2 over a time interval and generating an error duration signal S3; receiving, by a second multiplier, the error duration signal S3; receiving, by the second multiplier, by a guard margin value Tₜₕ; multiplying, by the second multiplier, the error duration signal S3 by the guard margin value Tₜₕ and generating time limited error duration signals S4; receiving, by a sign detector, the time limited error duration signals S4; generating, by the sign detector, one of a positive unity pulse S5⁺ when each time limited error duration signal S4 is greater than zero and a negative unity pulse S5⁻ when each time limited error duration signal S4 is less than or equal to zero; detecting, by the sign detector, the steady state event of the error signals when a negative unity pulse S5⁻ transitions to a positive unity pulse S5⁺; transmitting the positive unity pulse to a positive edge triggered circuit upon detecting the transition to the positive unity pulse S5⁺; generating, by the positive edge-triggered circuit, a trigger pulse gᵢ(t) upon receiving the positive unity pulse S5⁺; transmitting the trigger pulse gᵢ(t) to the integrator; and eliminating integrator wind-up by resetting the integrator to zero with the trigger pulse gᵢ(t).

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a schematic diagram of an exemplary interconnected industrial plant, according to certain embodiments.

FIG. 2 illustrates a schematic diagram of an interconnected dynamical plant with input-output correspondence, according to certain embodiments.

FIG. 3 illustrates a negative decentralized feedback control system implemented to enforce set point compliance, according to certain embodiments.

FIG. 4A illustrates a system implementing a hybrid discrete-continuous control procedure to eliminate steady state error in a plant, according to certain embodiments.

FIG. 4B illustrates the system where the re-injection of the steady state control signal is introduced when the error (E) is zero, according to certain embodiments.

FIG. 5A illustrates a fixed point iteration procedure for monotonic convergence used in constructing a decentralized controller, according to certain embodiments.

FIG. 5B illustrates a fixed point iteration procedure for oscillating convergence, according to certain embodiments.

FIG. 5C illustrates a fixed point iteration procedure for monotonic divergence, according to certain embodiments.

FIG. 5D illustrates a fixed point iteration procedure for oscillating divergence, according to certain embodiments.

FIG. 6 illustrates a decentralized controller for steady state error cancellation, according to certain embodiments.

FIG. 7 illustrates a trigger circuit configured for triggering a sample and hold circuit, according to certain embodiments.

FIG. 8A illustrates a mass-spring coupled system 800 tested for error cancellation through simulation, according to certain embodiments.

FIG. 8B shows a decentralized controller which performs steady state error cancellation on the mass-spring coupled system of FIG. 8A, according to certain embodiments.

FIG. 8C shows an actuator connected to the control system of FIG. 8A, according to certain embodiments.

FIG. 9 illustrates response of the system without applying any external disturbance and without utilizing an iterative error cancellation procedure, according to certain embodiments.

FIG. 10 illustrates response of the system without applying any external disturbance but with the iterative error cancellation procedure implemented, according to certain embodiments.

FIG. 11 illustrates response of the system when a sinusoidal external disturbance is applied, without utilizing the iterative error cancellation procedure, according to certain embodiments.

FIG. 12 illustrates response of the system when a sinusoidal external disturbance is applied, with the iterative error cancellation procedure in place, according to certain embodiments.

FIG. 13 illustrates response of the system when a random high frequency external disturbance is applied, without utilizing the iterative error cancellation procedure, according to certain embodiments.

FIG. 14 illustrates response of the system when a random high frequency external disturbance is applied, with the iterative error cancellation procedure in place, according to certain embodiments.

FIG. 15 illustrates response of the system when a variable step load is applied, without utilizing the iterative error cancellation procedure, according to certain embodiments.

FIG. 16 illustrates response of the system when a variable step load is applied, with the iterative error cancellation procedure in place, according to certain embodiments.

FIG. 17A illustrates a schematic diagram of a coupled tank system, according to certain embodiments.

FIG. 17B illustrates a physical implementation of the coupled tank system, according to certain embodiments.

FIG. 18A illustrates a tank level over time, according to certain embodiments.

FIG. 18B illustrates a pump voltage over time, according to certain embodiments.

FIG. 19 illustrates a nonlinear model implemented in simulink environment, according to certain embodiments.

FIG. 20 illustrates an iterative error cancellation model applied to the nonlinear model of the coupled tank system, according to certain embodiments.

FIG. 21A illustrates response of the tank level control system using an error cancellation controller, according to certain embodiments.

FIG. 21B illustrates depicts a motor voltage applied to a pump in the tank level control system using an error cancellation controller, according to certain embodiments.

FIG. 22 illustrates an experimental setup used for testing the iterative error cancellation procedure, according to certain embodiments.

FIG. 23 illustrates a block diagram of a position control system used in the experimental setup, according to certain embodiments.

FIG. 24 illustrates a circuit connection diagram for the position control system, according to certain embodiments.

FIG. 25 illustrates a circuit connection diagram for the position control system having error introduced in calibration explanation, according to certain embodiments.

FIG. 26 illustrates a block diagram of the position control system with an external disturbance, according to certain embodiments.

FIG. 27 illustrates a circuit connection for the position control system with an external disturbance, according to certain embodiments.

FIG. 28 illustrates a block diagram of the position control system incorporating a sample and hold circuit for implementing the iterative error cancellation procedure, according to certain embodiments.

FIG. 29 illustrates a circuit connections for the position control system integrated with the sample and hold circuit, according to certain embodiments.

FIG. 30A illustrates an error channel output voltage over time samples, according to certain embodiments.

FIG. 30B illustrates a motor system input voltage over time samples, according to certain embodiments.

FIG. 31 illustrates a testing bench and equipment setup for evaluating the iterative error cancellation procedure, according to certain embodiments.

FIG. 32 illustrates a block diagram of a control system designed to manage a speed of a DC motor, using a manual sample and hold circuit, according to certain embodiments.

FIG. 33 illustrates a circuit connection diagram for a speed control system including a manual sample and hold circuit, according to certain embodiments.

FIG. 34 illustrates a graphical representation of a drop in servo-motor speed in revolutions per minute (RPM) due to the sudden application of load torque, according to certain embodiments.

FIG. 35 is an illustration of a non-limiting example of details of a computing hardware used in the computing system, according to certain embodiments.

FIG. 36 is an exemplary schematic diagram of a data processing system used within the computing system, according to certain embodiments.

FIG. 37 is an exemplary schematic diagram of a processor used with the computing system, according to certain embodiments.

FIG. 38 illustrates a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a decentralized controller and method designed to cancel steady-state errors in a plant system comprising multiple components. Each component of the system is equipped with an individual error control loop. The error control loop includes mechanisms to handle steady-state control signals and plant output signals. Each error control loop involves a first multiplier that processes a set point value and plant output signals to generate error signals, an amplifier that enhances these error signals, and a trigger circuit that identifies steady-state events in the error signals and generates corresponding trigger pulses. Additionally, a sample and hold circuit uses the trigger pulses and negative steady-state control signals to create a steady-state error cancellation signal. The steady-state error cancellation signal is then reintroduced into the error control loop, effectively reducing steady-state errors, and ensuring precise system control.

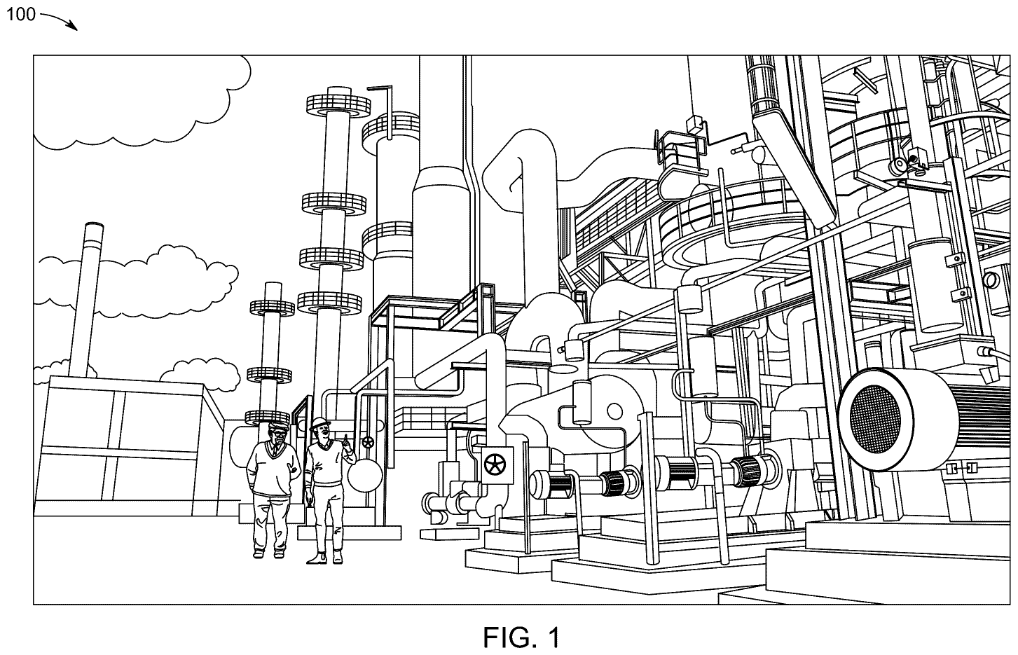

FIG. 1 illustrates an interconnected industrial plant 100. The interconnected industrial plant 100, alternatively referred as to the plant 100, is a network of components operating under tightly regulated and predictable conditions. The network of various components, performing various operations in the plant 100, is referred to as a plant system. These components are configured to ensure the stability of the plant 100 and to maintain acceptable dynamic behavior during operations.

A problem faced by the plant 100 is the varying and unpredictable load on its components. These loads can cause deviation from the desired set points assigned to each component, resulting in steady state error. The plant 100 ideally should be capable of continuously adjusting to these changing loads to maintain operational stability and efficiency.

The plant 100 includes various interconnected components that work together to manage the industrial processes. Despite being designed for stability, the plant 100 experiences the fluctuations in load, which can lead to deviations and potential errors in the system.

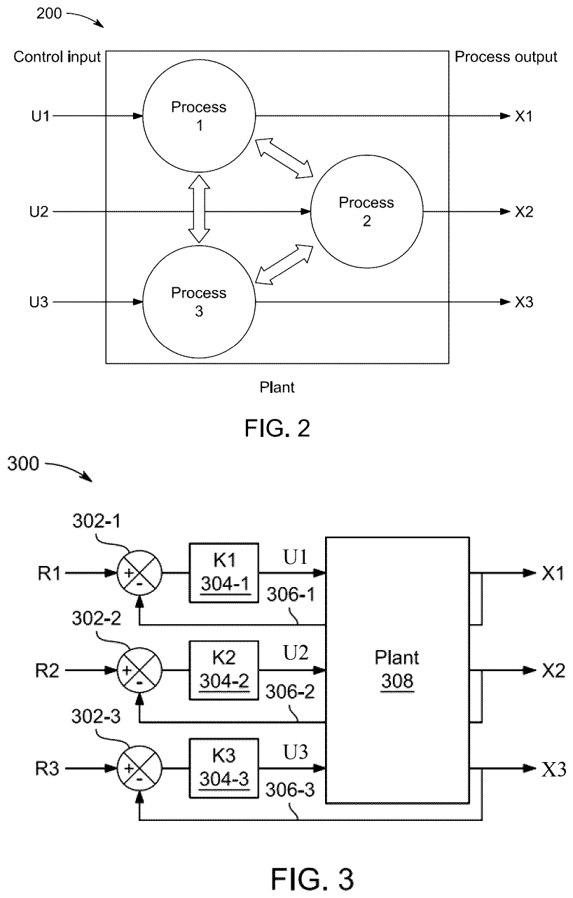

FIG. 2 illustrates an interconnected dynamical plant 200 with input-output correspondence. The interconnected dynamical plant, also referred to as the plant 200, includes a plurality of processes. In an illustrated example, the plant 200 includes process 1, process 2, and process 3. Each process is associated with a control input and a process output. The control inputs are denoted as U1, U2, and U3, while the process outputs are denoted as X1, X2, and X3, respectively.

In the plant 200, process 1 receives control input U1 and produces process output X1. Process 1 interacts with process 2, allowing for dynamic interaction between these processes. Process 2 receives control input U2 and produces process output X2. Process 2 interacts with both process 1 and process 3, facilitating the dynamic behavior of the plant 200. Process 3 receives control input U3 and produces process output X3. Process 3 interacts with process 2, further contributing to the dynamic interconnections within the plant 200.

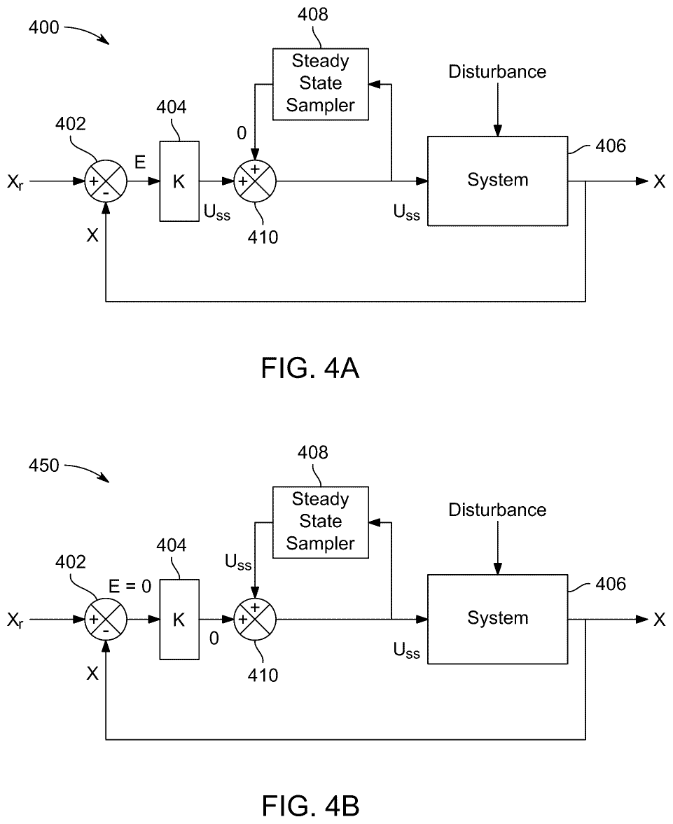

FIG. 3 illustrates a negative decentralized feedback control system 300 implemented to enforce set point compliance. The control system 300, implemented for a plant 308, is designed to drive the value of an output to a desired set point value (Ri) using negative feedback control (uᵢ) with positive gain (Kᵢ) in the forward loop.

The control system 300 includes three processes. A first process includes a first multiplier (302-1) to receive as set value of reference inputs R1, which represent the reference set point values for the process outputs X1, a first amplifier (304-1) and a corresponding feedback loop (306-1). A second process includes a second multiplier (302-2) to receive as set value of reference inputs R2, which represent the reference set point values for the process outputs X2, a second amplifier (304-2) and a corresponding feedback loop (306-2). A third process includes a third multiplier (302-3) to receive as set value of reference inputs R3, which represent the reference set point values for the process outputs X3, a third amplifier (304-3) and a corresponding feedback loop (306-3). Each of the corresponding feedback loop (306-1, 306-2, 306-3) includes a multiplier (302-1, 302-1, and 302-3, combinedly denoted by 302) and an amplifier (304-1, 304-1, and 304-3, combinedly denoted by 304). The multipliers 302 compare the process output with the reference set point value and generate an error signal. The amplifiers 304 amplify the error signal to produce the control inputs (U1, U2, U3) for the plant 308.

To drive the value of the process output (X1, X2, and X3) to the set value of reference input Ri, a negative feedback control (uᵢ) is established between the process output and the corresponding input with positive gain (Kᵢ) in the forward loop. The negative feedback control (Kᵢ) is derived by:

$${u}_{i} = {K}_{i} ( {R}_{i} - {X}_{i} ) = {K}_{i} ( {u}_{i} ) ; i = 1 … N \qquad ( 1 )$$

where N is the number of plant outputs/inputs.

The number N is related to the number of interconnected components within the industrial plant which are controlled by the controller of the present disclosure. There may be thousands of interconnected components within the industrial plant. A decentralized controller can be placed individually on each component of the system without having to consider the other components so that the components achieve their required set point without interfering in the ability of the other components of the plant to achieve its required set point. The number N is upper bounded by cost and space design constraints.

The negative, decentralized proportional state feedback of the interconnected stable system ensures that each output has a corresponding input, maintaining the stability of the interconnected components of the plant 308. However, the feedback does not cause the output convergence to the desired reference. Therefore, the forward gains in the error channels (Kᵢ) cannot be used for controlling the error. The forward gains are only used to obtain good transient behavior of the system.

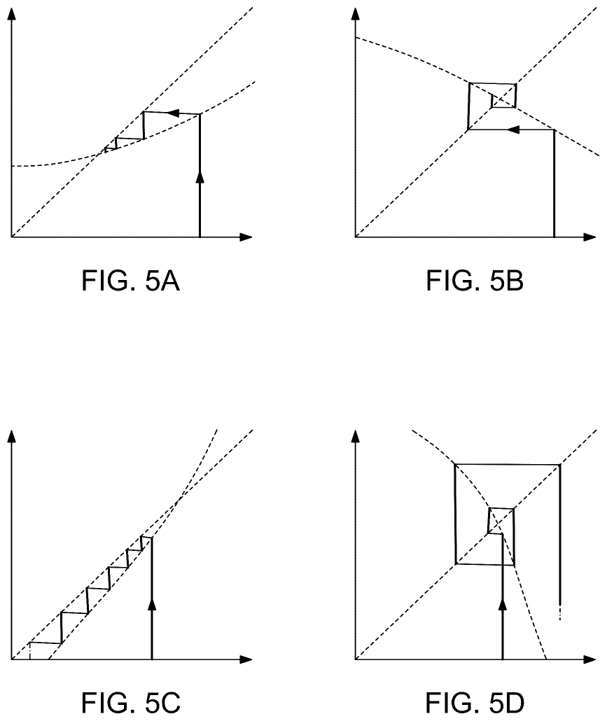

FIG. 4A illustrates a system 400 implemented to eliminate steady state error in a plant. The steady state error is eliminated by a hybrid, discrete-continuous control processes implemented within a plant. The plant includes a plurality of system blocks 406. Each system block is implemented with a corresponding control process.

The system 400 re-injects the steady state control signal of a component of the plant into its corresponding error channel. In the system 400, an alternative control channel is provided to supply the steady state control signal and nullify the error channel. The system 400 includes a first multiplier 402, an amplifier 404, a second multiplier 410, and the system block 406. The first multiplier 402 receives a reference input (Xᵣ) and a process output (X), generating an error signal (E). The error signal (E) is amplified by the amplifier 404 to produce the control input (uₛₛ). The system 400 further includes a steady state sampler 408, implemented between a second multiplier 410 and the system block 406. The steady state sampler 408 re-injects the steady state control signal (uₛₛ) into the error channel at the first multiplier 402, thereby ensuring that the control input to the system block 406 is appropriately adjusted to eliminate the steady state error. The system block 406 represents the component of the plant subject to disturbances and produces the process output (X).

FIG. 4B illustrates the system 450, similar to the system 400 as shown in FIG. 4A, where the re-injection of the steady state control signal is introduced when the error (E) is zero. The system 450 includes the components, as described in FIG. 4A. When the error (E) is zero, the control input (uₛₛ) is re-injected into the system block 406, ensuring the elimination of the steady state error and maintaining the process output (X) at the desired reference value (Xr).

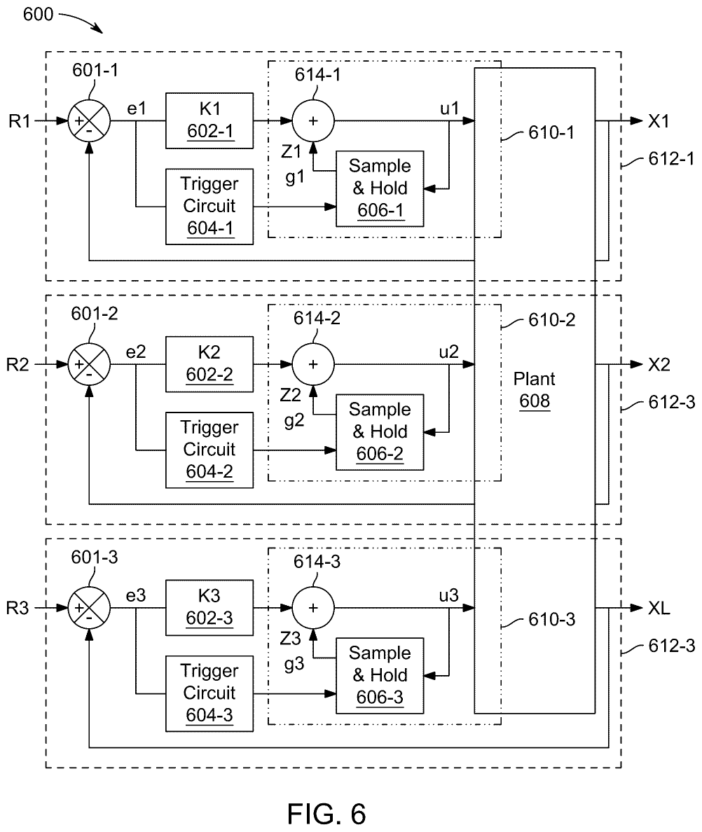

FIG. 5A-FIG. 5D illustrate the fixed point iteration procedure used in constructing the decentralized controller. The fixed point iteration method is employed to determine the value of the steady state control signal that can cancel the steady state error. Fixed-point iteration is a computational technique utilized to determine the fixed point of a function. A fixed point of a function g(x) is a g(x) is a point x that satisfies the condition x=g(x). The fixed-point iteration involves starting with an initial guess and iteratively applying the function to approximate the fixed point. The graphical representation in FIG. 5 demonstrates the iterative process where the control signal is adjusted to converge to the fixed point, thereby eliminating the steady state error. The figures show various iterations converging towards the desired fixed point, illustrating the effectiveness of the procedure in achieving steady state control. In an example, FIG. 5A illustrates a fixed point iteration procedure for monotonic convergence used in constructing a decentralized controller. FIG. 5B illustrates a fixed point iteration procedure for oscillating convergence. FIG. 5C illustrates a fixed point iteration procedure for monotonic divergence. FIG. 5D illustrates a fixed point iteration procedure for oscillating divergence.

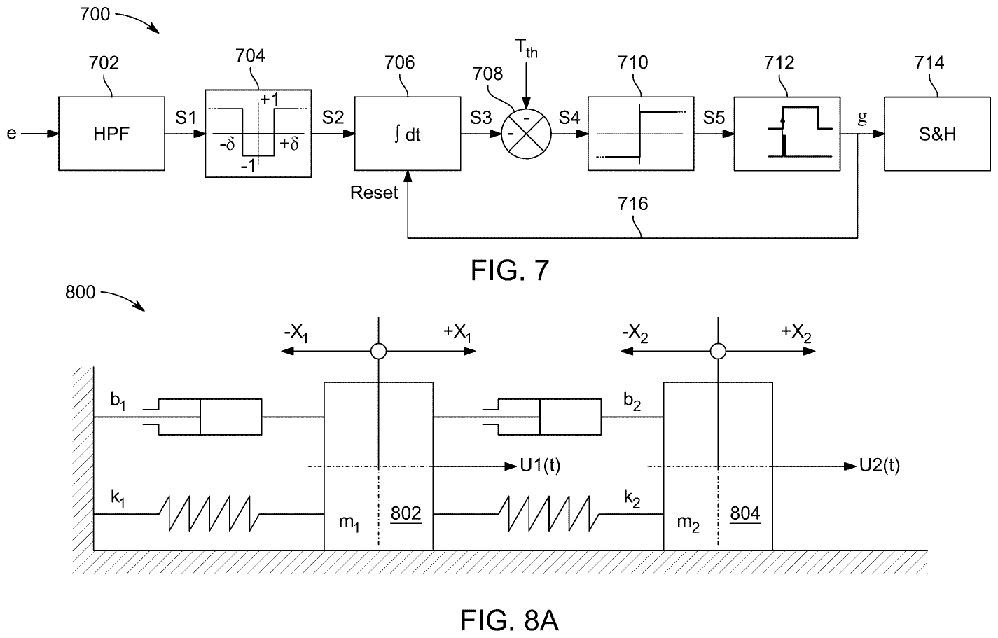

FIG. 6 illustrates a decentralized controller 600 for steady state error cancellation proposed in the present disclosure. The stead state error cancellation is achieved in a plant 608 using a hybrid, discrete-continuous control procedure to eliminate steady state error. The decentralized controller, alternatively referred to as a controller 600, is implemented to control a number N of components of the plant 608. For each component i, where i=1, 2, . . . , N, the controller 600 includes an error control loop. Each control loop includes steady state control signals uᵢ(t) and plant output signals Xᵢ(t) each control loop includes steady state control signals uᵢ(t) and plant output signals Xᵢ(t).

The controller 600 is designed to re-inject the steady state control signal of a component of the plant into its corresponding error channel, ensuring that the control input (uᵢ(t)) effectively eliminates the steady state error. For re-injecting, a signal injection module, consisting of sample and hold circuits (606-1, 606-2, and 606-3) and trigger circuit (604-1, 604-2, and 604-3), is implemented.

Each error control loop includes a first multiplier, combinedly denoted by 601, configured to receive a set point value Rᵢ and the plant output signals Xᵢ(t), multiply the set point value Rᵢ by a negative value of the plant output signals Xᵢ(t) and generate error signals eᵢ(t). Where, i is a component from N components. Each error loop further includes an amplifier, combinedly denoted by 602, connected to an output terminal of the first multiplier. The amplifier 602 is configured to amplify the error signals eᵢ(t) by a gain Kᵢ and generate amplified error control signals Kᵢ·uᵢ(t).

Each error loop further includes a stead state event detector, is also referred to as a trigger circuit, combinedly denoted by 604. The trigger circuit 604 is connected to the output terminal of the first multiplier. The trigger circuit 604 is configured to receive the error signals eᵢ(t), detect a steady state event of the error signals and generate a trigger pulse gᵢ(t) based on detecting the steady state event. Each error loop further includes a sample and hold circuit, combinedly denoted by 604, is configured to receive the trigger pulse gᵢ(t) and negative values of the steady state control signals uᵢ(t), generate a steady state error cancellation signal Z(t)ᵢ and inject the steady state error cancellation signal Z(t)ᵢ into the error control loop.

As illustrated in FIG. 6, a first error control loop includes a first multiplier 601-1 configured to receive a set point value R1, an amplifier 602-1, an error signal e1, the sample and hold circuits 606-1, the trigger circuit 604-1, a second multiplier 614-1, a control input u1, and a process output X1.

A second error control loop includes a first multiplier 601-2 configured to receive a set point value R2, an amplifier 602-2, an error signal e2, the sample and hold circuits 606-2, the trigger circuit 604-2, a second multiplier 614-2, a control input u2, and process output X2.

A third error control loop includes a first multiplier 601-3 configured to receive a set point value R3, an amplifier 602-3, an error signal e3, the sample and hold circuits 606-3, the trigger circuit 604-3, a second multiplier 614-3, a control input u3, and process output X3.

The multiplier 601 of the three processes is configured to receive a set point value Rᵢ (R1, R2, and R3) and the plant output signals Xᵢ(t), multiply the set point value Rᵢ by a negative value of the plant output signals Xᵢ(t) and generate error signals (e1, e2, and e3).

The error signals (e1, e2, and e3) are amplified by the amplifiers (602-1, 602-2, and 602-3) to produce the control inputs (u1, u2, u3). The amplifier 602 is configured to amplify the error signals by a gain Kᵢ and generate amplified error control signals.

The trigger circuit 604 is activated when the system reaches a steady state. The trigger circuit 604 is configured to receive the error signals (e1, e2, and e3), detect a steady state event of the error signals (e1, e2, and e3), and accordingly generate a trigger pulse gᵢ(t) based on detecting the steady state event.

The sample and hold circuits (606-1, 606-2, and 606-3) are configured for receiving trigger pulses and negative values of the steady state control signals, and then generating the steady state error cancellation signals (z1, z2, and z3), respectively. The steady state error cancellation signals are injected into the error control loop at the second multiplier (614-1, 614-2, and 614-3). The sample and hold circuits (606-1, 606-2, and 606-3) ensure that the control inputs (u1, u2, and u3) are appropriately adjusted to eliminate the steady state error by maintaining the steady state control signals.

In one aspect, each error control loop of the controller 600 includes two feedback loops. First feedback loop, (610-1, 610-2, and 610-3), corresponding to each respective process, is configured to transmit the steady state control signals uᵢ(t) to the sample and hold circuits 606. A second feedback loop, (612-1, 612-2, and 612-3), corresponding to each respective process, is configured to transmit negative values of the plant output signals Xᵢ(t) to the multiplier 601.

The plant 608 represents the interconnected processes that receive the control inputs u1, u2, and u3 and produce the process outputs (X1, X2, and X3). The plant 608 operates under varying and unpredictable loads, which the controller 600 compensates for by continuously adjusting the control inputs on the error signals.

The signal fed to the control input (uᵢ(t)) of the plant 608 has the form of:

$$\begin{matrix}{u}_{i} = {K}_{i} {e}_{i} ( t ) + Zi ( t ) \\ Zi ( t ) = u s i ( {t}_{j} ) Φ ( t - {t}_{j} )\end{matrix} \qquad ( 2 )$$

where usᵢ (tⱼ) is the estimate of steady state value of the i^{th} control signal (usᵢ (0)=0), tⱼ is the instant the response of the system reaches steady state after the injection of the previous value of the steady state error that happened at instant tⱼ−1 and Φ(t) is the unit step function. The unit step function is described as:

$$Φ ( t ) = [ \begin{matrix}0 & t < 0 \\ 1 & t \geq 0\end{matrix} ] \qquad ( 3 )$$

When t is less than 0, the step function is assigned with value 0, and when t is equal or greater than 0, the step function is assigned with a value 1.

The controller 600 ensures that once the error is cancelled ((eᵢ(t)=0)), and there is no change in the steady state value of the control signal, preventing any transient from being triggered. The update process stops, leaving only the constant value of the steady state control signal usᵢ (tⱼ)−usᵢ (tⱼ₋ᵢ) Φ(t−tⱼ) that corresponds to the update instant before the error was strictly or effectively cancelled. In other words, the update process naturally stops and only a constant value of the steady state control signal that corresponds to the update instant before the error got strictly or effectively cancelled remains in the control signal.

In one aspect, the sample and hold circuits (606-1, 606-2, and 606-3) are configured with periodic triggering capabilities. Period of the periodic triggering is set as such to ensure the steady state of the controller 600 is reached.

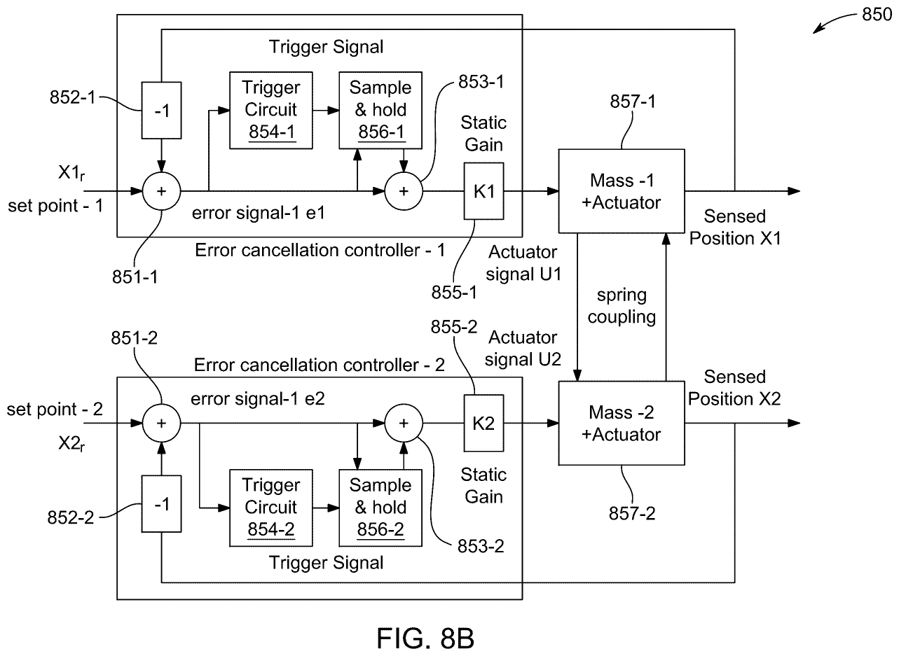

FIG. 7 illustrates a trigger circuit 700 configured for triggering a sample and hold circuit.

Integral windup, also known as integrator windup or reset windup, is a phenomenon associated with PID controllers, particularly when there is a significant and sudden change in the setpoint. Such situation arises because the integral term in the PID controller continuously sums the error over time, which is designed to eliminate steady-state error. However, during a large setpoint change, the integral term can accumulate a substantial error, leading to an excessive corrective action.

When the setpoint changes drastically, i.e., a positive step change, the error between the setpoint and the process variable becomes large. The integral component, which sums this error over time, starts to grow. Such accumulation continues during the rise phase (windup), resulting in a large integral value. As the process variable approaches the new setpoint, the accumulated integral error can cause the system to overshoot the setpoint because output of the controller is significantly influenced by the large integral “c” term. The system might then oscillate around the setpoint, as the controller output continues to be affected by the residual integral error, which takes time to “unwind” or reduce as it is offset by errors in the opposite direction.

The unwinding process is problematic because it prolongs the time it takes for the system to stabilize at the new setpoint, potentially causing prolonged oscillations or instability. In severe cases, this can degrade the performance of the control system or even lead to control system failure. Therefore, mitigation of the integral windup is required, and various strategies have been implemented for the mitigation. In an aspect of the present disclosure, a trigger circuit is configured to eliminate the steady-state error.

The trigger circuit 700 is integrated into a broader control framework, designed to optimize error handling through immediate response once a steady state condition is detected. The trigger circuit 700 includes a high-pass filter (HPF) 702, which receives an error signal eᵢ(t), generates high pass filtered error signals S1, and filters out low-frequency components, thus emphasizing the high-frequency fluctuations that are indicative of system dynamics.

The output of the high-pass filter 702 is then processed by a non-linearity detector 704 of the trigger circuit 700. The non-linearity detector 704 is configured to receive each high pass filtered error signal S1, compare an absolute value of the high pass filtered error signal S1 to a non-linearity threshold value δ and generate transformed signals S2 comprising one of a positive unity signal S2⁺ and a negative unity signal S2⁻ based on the absolute value of the high pass filtered error signal S1 being greater or less than and equal to than the non-linearity threshold value δ respectively.

The non-linearity detector 704 transforms the filtered signal into discrete states. Specifically, if the magnitude of the input signal exceeds a predefined threshold, the output is assigned a positive value; otherwise, it is assigned a negative value, as expressed in Equations (4) and (5). Such transformation must be achieved to determine the stability of the system. The processed signal from the non-linearity detector 704 is then integrated by an integrator 706. The integrator 706 is configured to receive the transformed signals S2, integrate the transformed signals S2 over a time interval and generate an error duration signal S3. The integrator 706 accumulates the signal over time to reflect the duration for which error activities of the system remain within a narrow band. This accumulation is represented as signal S3.

The trigger circuit 700 further include a second multiplier 708 which is configured to receive the error duration signal S3, multiply the error duration signal S3 by a guard margin value T^{th} and generate time limited error duration signals S4. The second multiplier 708 thus ensures that the error has sufficiently settled.

Upon detecting that the error has settled, the second multiplier 708 transitions its output signal S4 from a negative to a positive value, indicating a steady state condition. The transition is captured by a sign detector 710. The sign detector 710 detects the steady state event of the error signals when a negative unity pulse S5⁻ transitions to a positive unity pulse S5⁺ and transmits the positive unity pulse to the positive edge triggered circuit upon detecting the transition to the positive unity pulse S5⁺ to activate a sample and hold circuit 714. The trigger circuit also includes a positive edge-triggered circuit 712 connected to the sign detector 710. The positive edge-triggered circuit 712 is configured to generate the trigger pulse gᵢ(t) upon receiving the positive unity pulse S5⁺.

The activation of the sample and hold circuit 714 captures the current steady state control signal and holds it constant, preventing further changes until the next steady state condition is detected. Additionally, the trigger circuit 700 includes a reset loop 716 which is configured to transmit the trigger pulse gᵢ(t) to the integrator 706. The trigger pulse is configured to reset the integrator 706 to zero to avoid integrator wind-up. Such automated triggering process ensures timely cancellation of the steady state error by accurately detecting and responding to steady state events, thus maintaining optimal system performance.

As illustrated in FIG. 7, a method for managing the precise timing of control actions within a control system environment starts by applying the high-pass filter 702 to the error signal, which provides an initial estimate of the fluctuations in response of the trigger circuit 700. The filtered signal is passed through a nonlinearity that transforms the signal as follows:

$$S 2 = [ \begin{matrix}+ 1 & \vert S 1 \vert > δ \\ - 1 & \vert S 1 \vert \leq δ\end{matrix} ] \qquad ( 4 )$$

If the magnitude of the input |S1| to the nonlinearity is less than a small threshold value δ, indicating minimal changes in the error over time and suggesting that the motion is nearing a settled state, the output S2 is assigned a value of −1. However, if the magnitude of the input |S1| to the nonlinearity is greater than a small threshold value δ, the output S2 is assigned a value of +1. The non-linearity threshold value δ is a programmable value selected from one of a set consisting of 0.005, 0.01, 0.02 and 0.15. The non-linearity threshold value δ can be obtained experimentally or during a calibration procedure by adjusting δ by starting from a very small value, such as 0.005, then increasing it gradually to a practically acceptable value.

The output S2 from this nonlinearity is then fed into an integrator, producing a signal (S3) that indicates the duration for which the error remains within a narrow band defined by (−δ, δ). This duration is represented by the magnitude of the integrated signal. The signal S4 is derived from S3, incorporating a controllable guard margin (T^{th}) to ensure that the error has sufficiently settled, thereby allowing the remaining signal to accurately represent the steady-state error (ess).

Settling of the error is indicated by a transition of the sign of S4 from negative to positive which is detected by the sign nonlinearity:

$$S 5 = [ \begin{matrix}+ 1 & S 4 > 0 \\ - 1 & S 4 \leq 0\end{matrix} ] \qquad ( 5 )$$

In an example, when the input S4 is less than zero, the value −1 is assigned to the output S5, and when S4 is greater than zero, the value +1 is assigned to the output S5. Transition of S4 from −1 to +1 is indicative of overcorrection of the system by the control signal and increase in the error.

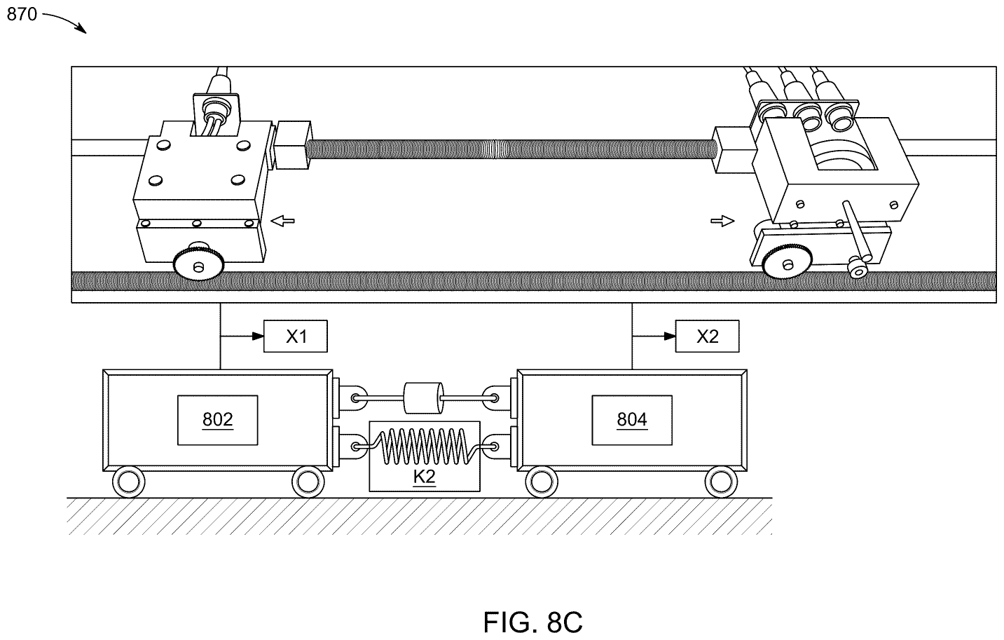

FIG. 8A illustrates a mass-spring coupled system 800 tested for error cancellation through simulation using the control system of the present disclosure. The system 800 comprises two masses m₁ 802 and m₂ 804, creating a coupled system with multiple inputs and outputs. Mass m₁ 802 is connected to a spring k₁ and a damper b₁ at one end, while mass m₂ 804 is connected to a spring k₂ and a damper b₂ at the other end. Further, mass m₁ 802 and m₂ 804 are connected by the damper b₂ and the spring k₂. The control inputs (U1(t)) and (U2(t)) are applied to the masses m₁ 802 and m₂ 804, respectively, influencing response of the system. The corresponding displacements of the masses, (−X₁, +X₁) and (−X₂, +X₂), serve as outputs of the system. In the mass-spring coupled system 800, the control approach utilizes unity gain velocity and position feedback for each control input independently. This ensures that the control inputs (U1(t)) and (U2(t)) directly influence the outputs (X1) and (X2). The system equation governing the dynamics of the coupled mass-spring system is represented by equation (6).

$$\begin{matrix}[ \begin{matrix}\dot{x} 1 \\ \ddot{x} 1 \\ \dot{x} 2 \\ \ddot{x} 2\end{matrix} ] = [ \begin{matrix}0 & 1 & 0 & 0 \\ - \frac{k 1 + k 2 )}{m 1} & \frac{( b 1 + b 2 )}{m 1} & \frac{k 2}{m 1} & \frac{b 2}{m 1} \\ 0 & 0 & 1 & 0 \\ \frac{k 2}{m 2} & \frac{b 2}{m 2} & - \frac{k 2}{m 2} & - \frac{b 2}{m 2}\end{matrix} ] [ \begin{matrix}x 1 \\ \dot{x} 1 \\ x 2 \\ \dot{x} 2\end{matrix} ] + [ \begin{matrix}0 & 0 \\ 1 & 0 \\ 0 & 0 \\ 0 & 1\end{matrix} ] [ \begin{matrix}U 1 \\ U 2\end{matrix} ] \\ [ \begin{matrix}x 1 \\ x 2\end{matrix} ] = [ \begin{matrix}1 & 0 & 0 & 0 \\ 0 & 0 & 1 & 0\end{matrix} ] [ \begin{matrix}x 1 \\ \dot{x} 1 \\ x 2 \\ \dot{x} 2\end{matrix} ]\end{matrix} \qquad ( 6 )$$

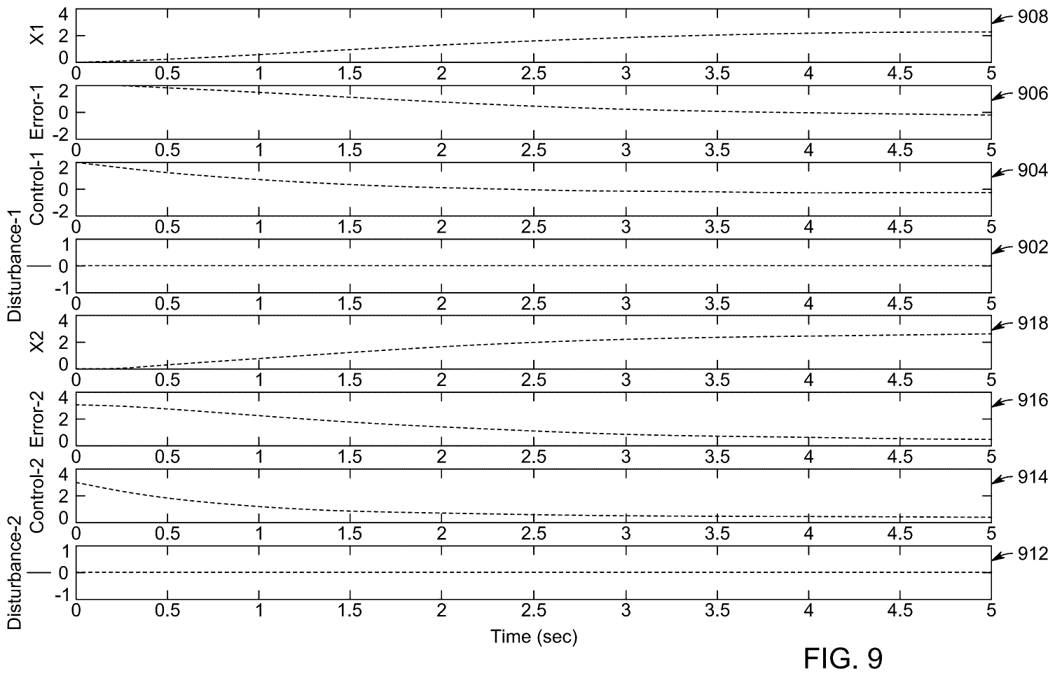

To evaluate the sensitivity of the proposed control procedure to the settling of transients, a short switching period of 0.05 seconds is selected. The reference values for the displacements are set to (X₁ᵣ=2) and (X₂ᵣ=3), providing target positions for the control system to achieve. This experimental setup and simulation framework validate the performance of the control approach in managing error cancellation within the mass-spring coupled system 800 as shown in FIG. 9.

FIG. 8B shows the decentralized controller which performs steady state error cancellation in each error control loop including the control of the first mass 802 by mass actuator 1 857-1, in a control loop in which the sensed position X1 is fed back to the set point X1ᵣ input as a negative feedback signal (see 852-1) and added at adder 851-1 to the set point X1ᵣ to form an error signal 1 (e1) which is applied to the trigger circuit 854-1 which detects the error signal e1 and feeds it to the sample and hold circuit 856-1. The error signal e1 is added by adder 853-1 to the output of the sample and hold circuit. The resulting signal is amplified by amplifier 855-1 having a gain K1 and fed to the mass actuator 857-1.

The control of the second mass 804 comprises a similar error control loop including mass actuator 2 857-2, in a control loop in which the sensed position X2 is fed back to the set point X2ᵣ input as a negative feedback signal (see 852-2) and added at adder 851-2 to the set point to form an error signal 2 (e2) which is applied to the trigger circuit 854-2 which detects the error signal e2 and feeds it to the sample and hold circuit 856-2. The error signal e2 is added at adder 853-2 to the output of the sample and hold circuit. The resulting signal is amplified by amplifier 855-2 having a gain K2 and fed to the mass actuator 857-2.

Mass actuator-1 857-1 is coupled by spring k2 to mass actuator-2 857-2. The different modules are connected to form the controller and convert the set point and value of the dynamical variable into a control signal. The trigger circuit and its components (including the reset of the integrator in the trigger circuits) influence the control signal and the control signal influences the variables X1 and X2.

FIG. 8C shows an actuator connected to the control system in which a spring k2 connects the two masses 802 and 804. The actuator is a motor in this example, by may be implementation specific.

FIG. 9 illustrates the system response 900 without applying any external disturbance and without utilizing the iterative error cancellation procedure. A waveform 908 represents the position output X₁ of the first mass m₁. As shown, X₁ does not reach the set point, remaining below the desired value. The error signal for X₁ is depicted by a waveform 906, which indicates the presence of a steady state error as it fails to converge to zero. The control input U1(t) for the first mass m₁ is represented by a waveform 904, demonstrating that the control input is ineffective in correcting the error, resulting in a persistent steady state error. A waveform 902 shows that no external disturbance is applied to the system. The position output X₂ of the second mass m₂ is illustrated by a waveform X2 918, which, similar to X1, fails to reach the set point. The error signal for X2 is shown by 916, demonstrating a steady state error. The control input U2(t) for the second mass m2 is depicted by a waveform 914, indicating the inability of the control input to eliminate the error. A waveform 912 confirms that no external disturbance is applied to the system. It can be seen that the system failed to settle at the set points and steady state error did occur.

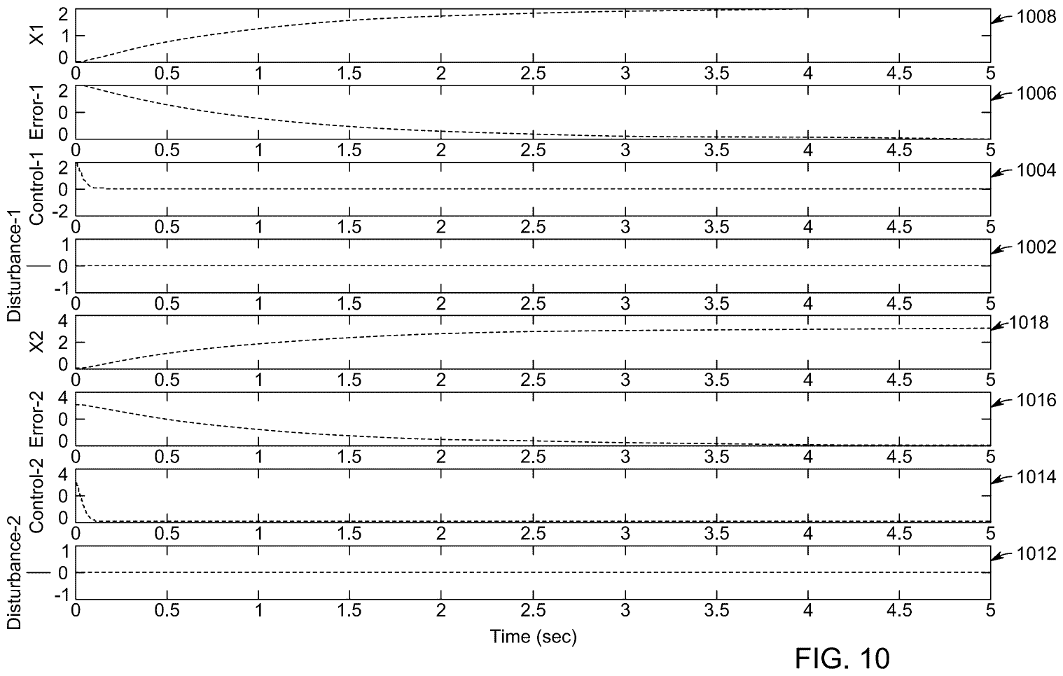

FIG. 10 illustrates the system response without applying any external disturbance but with the iterative error cancellation procedure implemented. A waveform 1008 demonstrates that the position output X₁ of the first mass m₁ successfully reaches the set point. The error signal for X₁ is depicted by a waveform 1006, which converges to zero, indicating the elimination of the steady state error. The control input U1(t) for the first mass m₁ is represented by a waveform 1004, showing the effectiveness of the control input in reaching the desired set point. A waveform 1002 confirms the absence of any external disturbance. The position output X₂ of the second mass m₂ is illustrated by a waveform 1018, which also successfully reaches the set point. The error signal for X₂ is depicted by a waveform 1016, converging to zero and indicating the elimination of the steady state error. The control input U2(t) for the second mass m2 is shown by a waveform 1014, demonstrating its effectiveness in reaching the desired set point. A waveform a waveform 1012 confirms the absence of any external disturbance. It can be seen that the system settles at the set points and steady state error is totally cancelled.

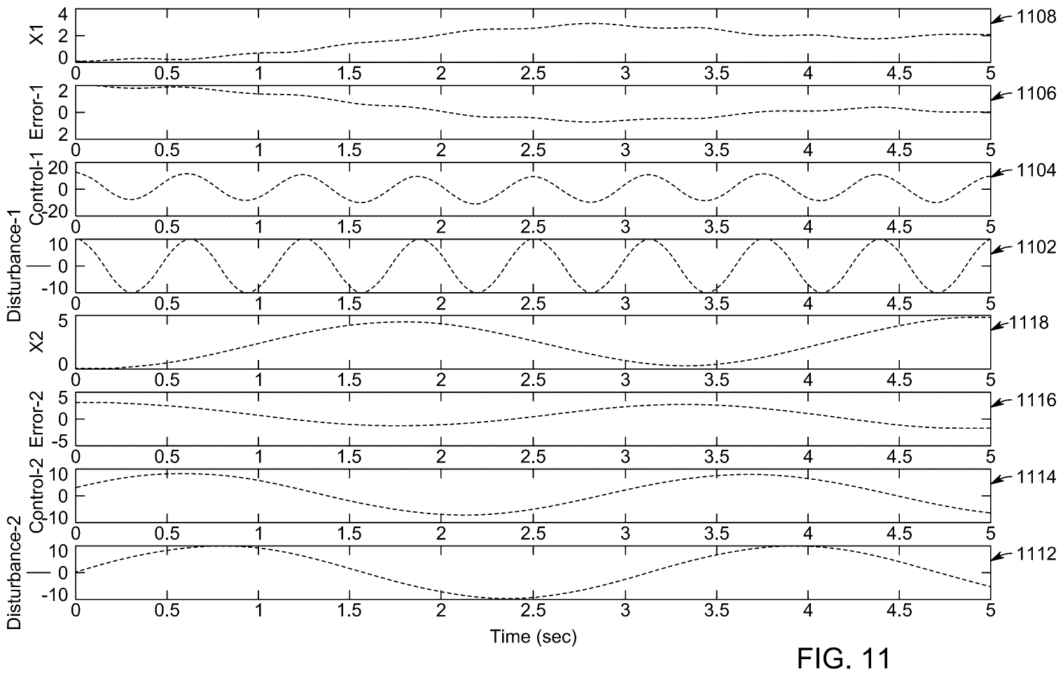

FIG. 11 illustrates the system response when a sinusoidal external disturbance is applied, without utilizing the iterative error cancellation procedure. A waveform 1108 represents the position output X₁ of the first mass m₁, showing fluctuations and failing to settle at the set point due to the disturbance. The error signal for X₁ is depicted by a waveform 1106, indicating a fluctuating steady state error. The control input U1(t) for the first mass m1 is represented by a waveform 1104, showing inability of the control input to correct the error under disturbance. A waveform 1102 illustrates the sinusoidal external disturbance applied to the system. The position output X₂ of the second mass m₂ is shown by a waveform 1118, also fluctuating and failing to settle at the set point. The error signal for X₂ is depicted by a waveform 1116, demonstrating the fluctuating steady state error. The control input U2(t) for the second mass m₂ is shown by a waveform 1114, indicating its ineffectiveness under disturbance. A waveform 1112 shows the sinusoidal external disturbance applied to the system. It can be seen that the system failed to settle at the set points and a fluctuating steady state error did occur.

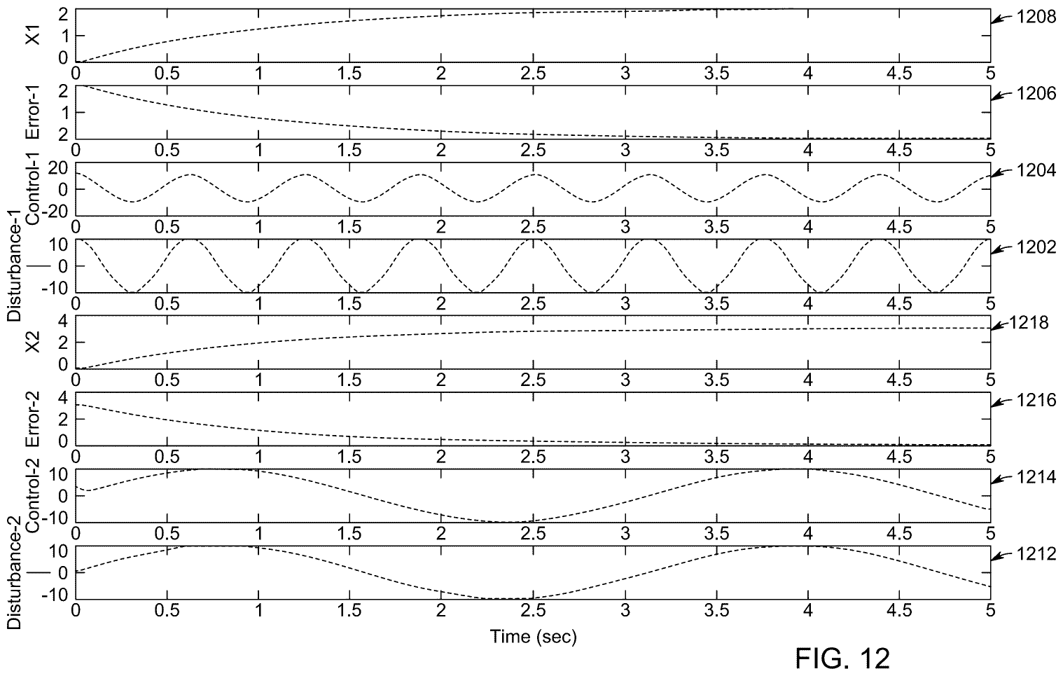

FIG. 12 illustrates the system response when a sinusoidal external disturbance is applied, with the iterative error cancellation procedure in place. A waveform 1208 demonstrates that the position output X₁ of the first mass m1 successfully reaches the set point despite the disturbance. The error signal for X₁ is depicted by a waveform 1206, which converges to zero, indicating the elimination of the steady state error. The control input U1(t) for the first mass m₁ is represented by a waveform 1204, showing effectiveness of the control input in correcting the error under disturbance. A waveform 1202 illustrates the sinusoidal external disturbance applied to the system. The position output X2 of the second mass m₂ is shown by a waveform 1218, which successfully reaches the set point despite the disturbance. The error signal for X₂ is depicted by a waveform 1216, converging to zero and indicating the elimination of the steady state error. The control input U2(t) for the second mass m₂ is shown by a waveform 1214, demonstrating its effectiveness under disturbance. A waveform 1212 shows the sinusoidal external disturbance applied to the system.

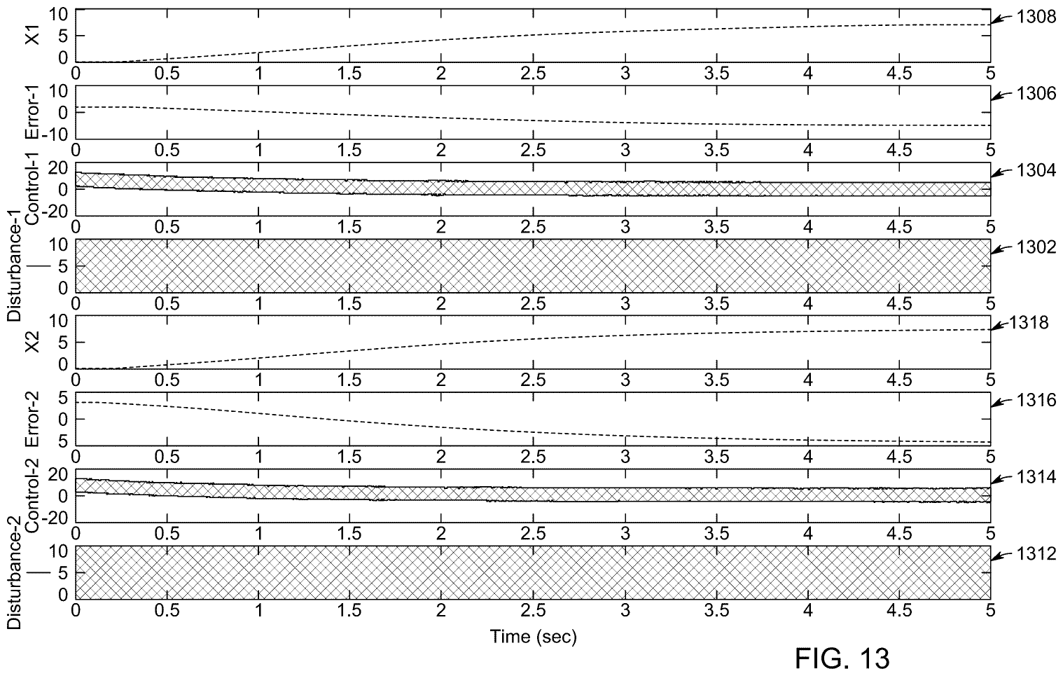

FIG. 13 illustrates the system response when a random high frequency external disturbance is applied, without utilizing the iterative error cancellation procedure. A waveform 1308 represents the position output X₁ of the first mass m₁, showing significant fluctuations and failing to settle at the set point. The error signal for X₁ is depicted by a waveform 1306, indicating a large steady state error. The control input U1(t) for the first mass m₁ is represented by a waveform 1304, showing inability of the control input to correct the error under disturbance. A waveform 1302 illustrates the random high frequency external disturbance applied to the system. The position output X₂ of the second mass m₂ is shown by a waveform 1318, also experiencing significant fluctuations and failing to settle at the set point. The error signal for X₂ is depicted by a waveform 1316, indicating the large steady state error. The control input U2(t) for the second mass m₂ is shown by a waveform 1314, indicating its ineffectiveness under disturbance. A waveform 1312 shows the random high frequency external disturbance applied to the system.

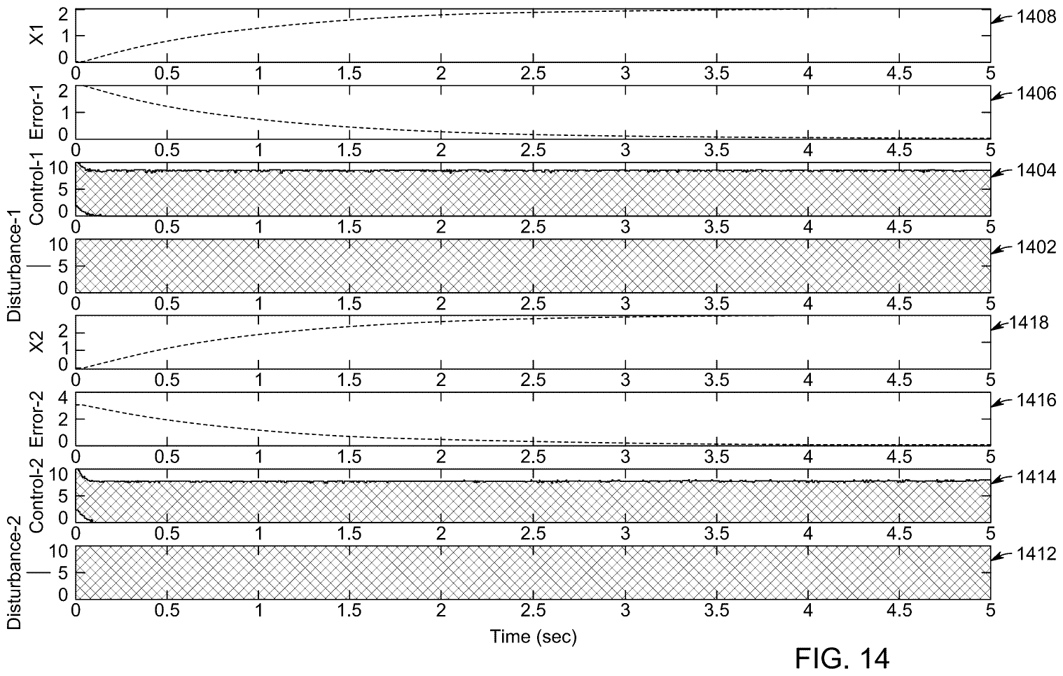

FIG. 14 illustrates the system response when a random high frequency external disturbance is applied, with the iterative error cancellation procedure in place. A waveform X₁ 1408 demonstrates that the position output X₁ of the first mass m₁ successfully reaches the set point despite the disturbance. The error signal for X₁ is depicted by a waveform 1406, which converges to zero, indicating the elimination of the steady state error. The control input U1(t) for the first mass m₁ is represented by a waveform 1404, showing effectiveness of the control input in correcting the error under disturbance. A waveform 1402 illustrates the random high frequency external disturbance applied to the system. The position output X₂ of the second mass m₂ is shown by a waveform 1418, which successfully reaches the set point despite the disturbance. The error signal for X₂ is depicted by a waveform 1416, converging to zero and indicating the elimination of the steady state error. The control input U2(t) for the second mass m₂ is shown by a waveform 1414, demonstrating its effectiveness under disturbance. A waveform 1412 shows the random high frequency external disturbance applied to the system.

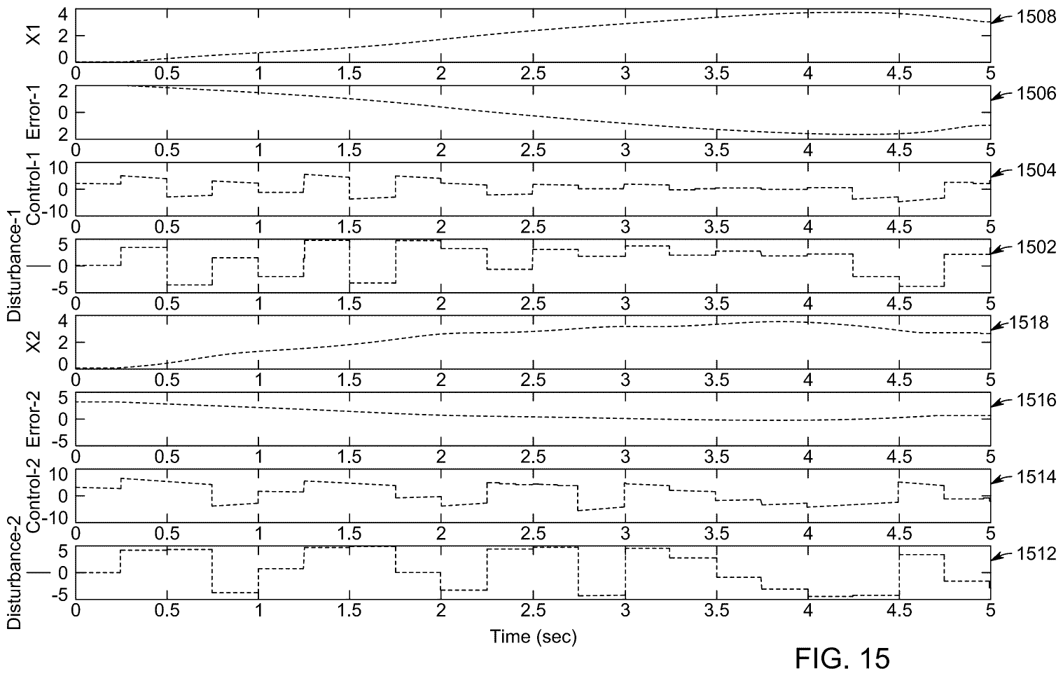

FIG. 15 illustrates the system response when a variable step load is applied, without utilizing the iterative error cancellation procedure. A waveform 1508 represents the position output X1 of the first mass m1, showing fluctuations and failing to settle at the set point due to the load. The error signal for X1 is depicted by a waveform 1506, indicating a large steady state error. The control input U1(t) for the first mass m1 is represented by a waveform 1504, showing ability of the control input to correct the error under load. The disturbance-1 is represented by a waveform 1502 which illustrates the variable step load applied to the system. The position output X2 of the second mass m2 is shown by a waveform 1518, also fluctuating and failing to settle at the set point. The error signal for X2 is depicted by a waveform 1516, demonstrating the large steady state error. The control input U2(t) for the second mass m2 is shown by a waveform 1514, indicating its ineffectiveness under load. A waveform 1512 shows the variable step load applied to the system.

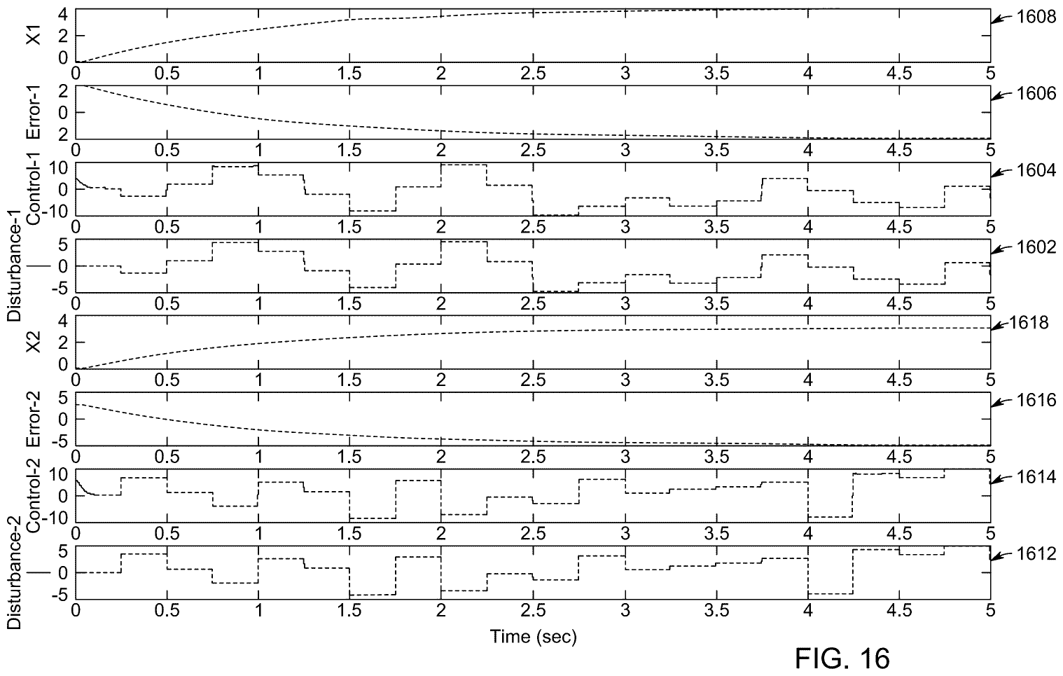

FIG. 16 illustrates the system response when a variable step load is applied, with the iterative error cancellation procedure in place. A waveform 1608 represents the position output X1 of the first mass m1, demonstrating that it successfully reaches the set point despite the applied variable step load. The error signal for X1 is depicted by a waveform 1606, which converges to zero, indicating the elimination of the steady state error. The control input U1(t) for the first mass m1 is represented by a waveform 1604, showing effectiveness of the control input in maintaining the set point under the variable step load condition. A waveform 1602 illustrates the variable step load applied to the system. The position output X2 of the second mass m2 is shown by a waveform 1618, which also successfully reaches the set point despite the applied variable step load. The error signal for X2 is depicted by a waveform 1616, converging to zero and indicating the elimination of the steady state error. The control input U2(t) for the second mass m2 is shown by a waveform 1614, demonstrating its effectiveness in maintaining the set point under the variable step load condition. A waveform 1612 shows the variable step load applied to the system.

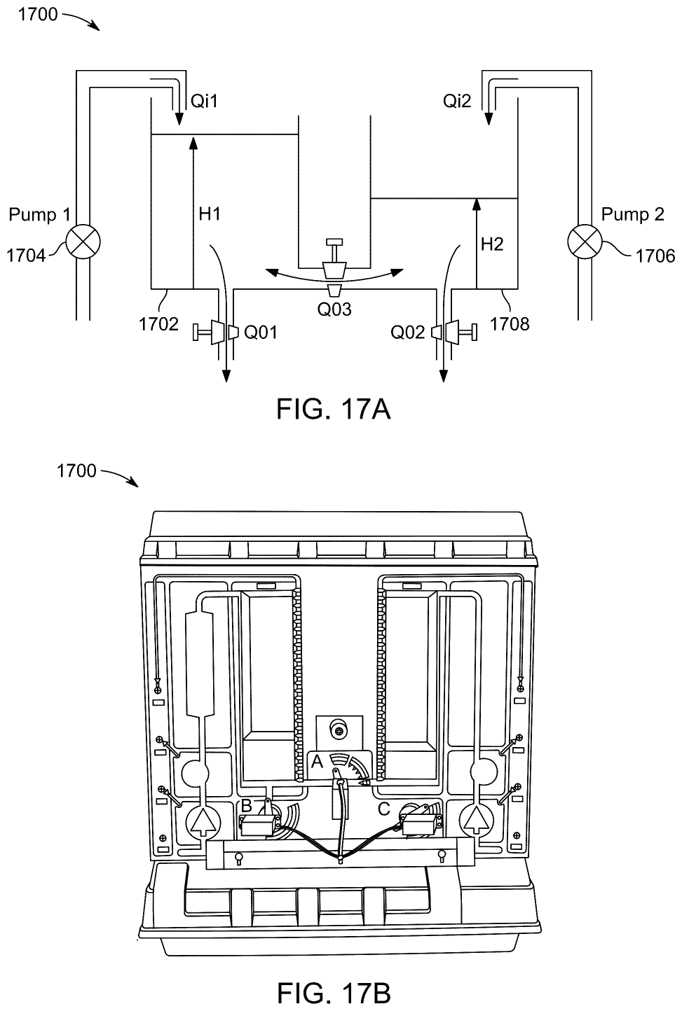

FIG. 17A and FIG. 17B illustrate another example of a coupled tank system 1700 used for level control experiments. In an example, the coupled tank system 1700 is a CE105MV vertical water tank system manufactured by TecQuipment LTD, Long Eaton, Nottingham, United Kingdom. The coupled tank system, also referred to as a system 1700, includes two vertical tanks, Tank1 1702 and Tank2 1708, interconnected by a flow channel Q03, which allows the liquid levels in the two tanks (1702, 1708) to interact dynamically.

In FIG. 17A, the system 1700 is shown schematically. The system 1700 includes Pump 1 1704 and Pump 2 1706, which are configured to supply liquid to Tank 1 1702 and Tank 2 1708, respectively. The inflow rates to Tank 1 1702 and Tank 2 1708 are denoted as Qi1 and Qi2. The levels of the liquid in Tank 1 1702 and Tank 2 1708 are represented by H1 and H2. The outflows from the tanks are represented by Q01, Q02, and Q03, with Q03 indicating the flow between the two tanks (1702, 1708) through the interconnecting channel.

In FIG. 17B, the physical implementation of the coupled tank system 1700 is depicted. The system 1700 includes two transparent vertical tanks (1702, 1708), a visual representation of the interconnected flow channels, and the associated control hardware and sensors. The components, such as the inflow pumps Qi1 and Qi2, valves, and sensors are visibly arranged on the system to facilitate easy monitoring and control during experiments. The front panel of the system 1700 provides visual access to the liquid levels (H1, H2) in the tanks (1702, 1708), enabling real-time observation of the control process.

The coupled tank system 1700 allows for experiments in both single-input single-output (SISO) and multi-input multi-output (MIMO) configurations. In the SISO mode, only Tank 1 is supplied with input from pump 1, while in the MIMO mode, both tanks receive inputs from their respective pumps. The system is designed to test various control strategies, including the iterative error cancellation procedure, by simulating real-world conditions such as variable inflow rates and interactive tank levels. The system 1700 provides a practical platform for evaluating the effectiveness of advanced control methods in maintaining desired liquid levels despite disturbances and dynamic interactions between the tanks.

The dynamic equation that relates the water level in each tank with the flow is

$${A}_{1} \frac{d {H}_{1}}{dt} = {Q}_{i 1} - {α}_{1} \sqrt{{H}_{1}} - {α}_{3} \sqrt{{H}_{1} - {H}_{2}} \qquad ( 7 )$$

$${A}_{2} \frac{d {H}_{2}}{dt} = {Q}_{i 2} - {α}_{2} \sqrt{{H}_{2}} + {α}_{3} \sqrt{{H}_{1} - {H}_{2}} \qquad ( 8 )$$

For SISO configuration output Q₀₁ of Tank 1 1702 is closed and Input Qᵢ₁ to Tank 2 1708 is not given, so the final equations for the SISO system can be written down in the form:

$$\frac{{dH}_{1}}{dt} = \frac{{Q}_{i 1} - {α}_{3} \sqrt{{H}_{1} - {H}_{2}}}{{A}_{1}} \qquad ( 9 )$$

$$\frac{{dH}_{2}}{dt} = \frac{- {α}_{2} \sqrt{{H}_{2}} + {α}_{3} \sqrt{{H}_{1} - {H}_{2}}}{{A}_{2}} \qquad ( 10 )$$

where A₁ and A₂ are the cross sectional areas of the tanks respectively, H₁ and H₂ are the heights of the water in the tanks and Qₒ₃ is the flow rate between the two tanks. Qₒ₁ and Qₒ₂ are the output flow rates of tank 1 and tank 2 respectively. Qᵢ₁ and Qᵢ₂ are the pump inflow rates into the tanks.

Using Bernoulli's Equation for viscous fluid flow, Qₒ₁, Qₒ₂, and Qₒ₃ in terms of the water heights as:

$${Q}_{01} = {α}_{1} \sqrt{{H}_{1}} \qquad ( 11 )$$

$${Q}_{D 2} = {α}_{2} \sqrt{{H}_{2}} \qquad ( 12 )$$

$${Q}_{03} = {α}_{3} \sqrt{{H}_{1} - {H}_{2}} \qquad ( 13 )$$

Here α₁, α₂ and α₃ are the coefficients of discharge dependent on the gravity and the cross sectional area of the channel:

$${α}_{1} = {s}_{1} {a}_{0} \sqrt{2 g} \qquad ( 14 )$$

$${α}_{2} = {s}_{2} {a}_{0} \sqrt{2 g} \qquad ( 15 )$$

$${α}_{3} = {s}_{3} {a}_{1} \sqrt{2 g} \qquad ( 16 )$$

Testing is performed for the SISO case with inlet flow of tank-1 as an input and water level in tank-2 as output. The parameters of the two tank system are given in the table below:

TABLE 1
Parameters of the tank system in FIG. 17A and FIG. 17B

| Parameter | Quantity | Value | |
|---|---|---|---|
| A₁, A₂ | Tank Section Area | 9350e−6 | sq. m |
| s₁, s₂, s₃ | Channel Sectional Area | 78.5e−6 | sq. m |
| a₀ | Discharge coefficient channel 1, 2 | 0.3 | |
| a₁ | Discharge coefficient channel 3 | 0.9 | |
| g | Gravitational Constant | 9.8 | m/s |

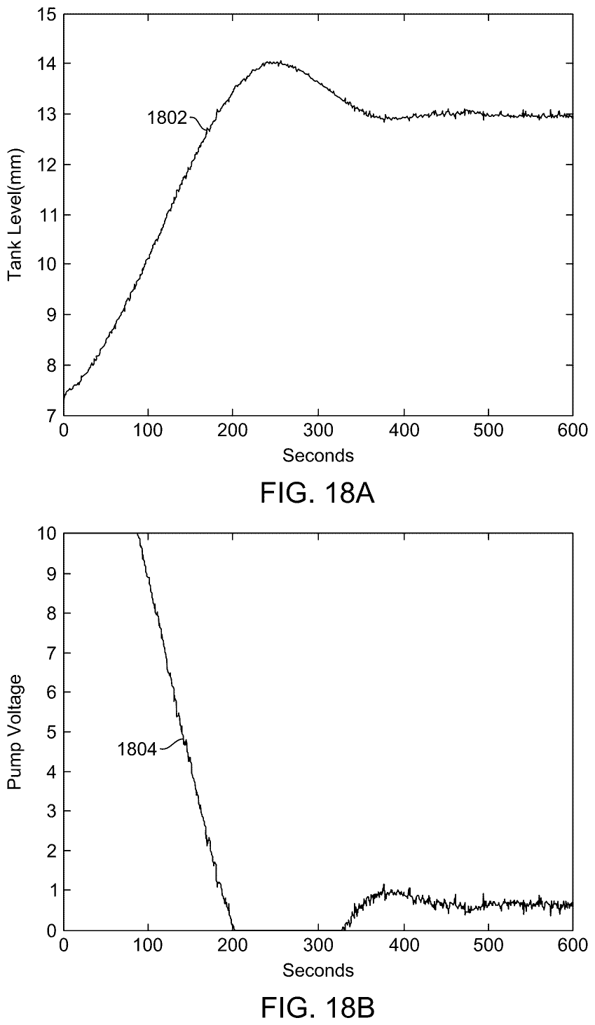

FIG. 18A depicts the tank level, represented by curve 1802, over time, indicating the water level response in millimeters as a function of time in seconds. The graph demonstrates rise of the water level to a peak before stabilizing at the set point.

FIG. 18B illustrates the pump voltage, represented by curve 1804, over time, showing the input voltage supplied to the pump as a function of time in seconds. The graph reflects the initial high voltage which gradually decreases and stabilizes as the tank level reaches the desired set point.

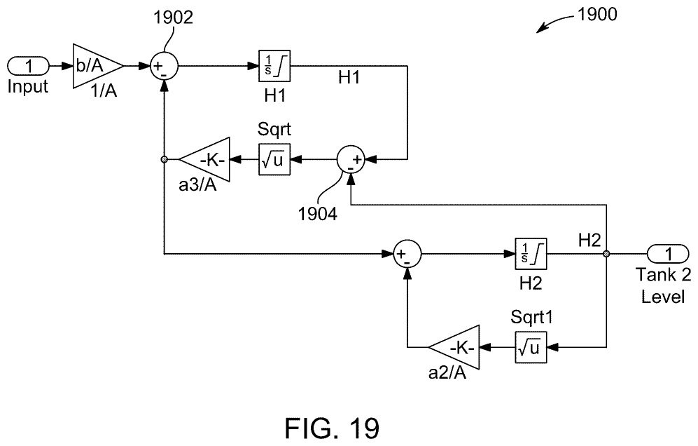

FIG. 19 presents a nonlinear model 1900 implemented in Simulink, representing the coupled tank system. The model 1900 includes integrator blocks H1 and H2, and summation points 1902 and 1904 to simulate the dynamic behavior of the water levels in the tanks. The inputs and outputs correspond to the water levels and control actions applied to maintain these levels. Parameters used to simulate the model 1900, parameters are set as shown in Table 2.

TABLE 2
Parameters used to simulate the suggested
controller on the tank system.

| Parameter | Value |
|---|---|
| Proportional gain | 0.7 |
| Alpha (α) | 0.001 |

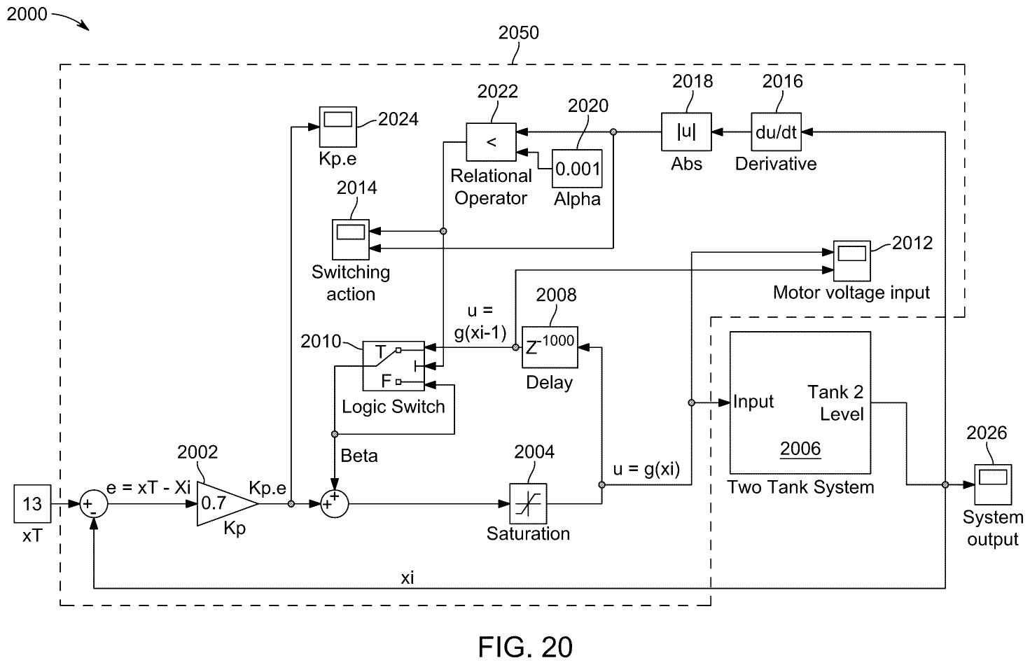

FIG. 20 shows the iterative error cancellation model 2000 applied to the nonlinear model of the coupled tank system. The iterative error cancellation controller 2050 includes a proportional gain (Kp) block 2002 that represents the proportional gain Kp. The Kp block 2002 multiplies the error signal by a gain factor 0.7 to produce a proportional control signal. An error signal (Kp.e) 2024 represents the product of the proportional gain Kp and the error signal e. The error signal e is the difference between the target setpoint xT and the current process variable xi. The trigger circuit is formed by 2016, 2018, 2020 and 2022. The sample and hold circuit is formed by 2008 and 2010. A saturation block 2004 represents the control signal to within specified upper and lower bounds, preventing excessive control actions. A two-tank system 2006 receives the motor voltage input 2012 and provides the tank level as an output. A delay block 2008 introduces a delay in the control signal. The delay block 2008 stores the previous value of the control signal and outputs it after a specified time period. A logic switch block 2010 switches the control input based on the condition evaluated by the relational operator. The logic switch block 2010 selects between the previous control input and the current control input. A switching action block 2014 controls the switching action based on the output of the relational operator. It determines whether to switch the control input or not. A derivative block 2016 computes the derivative of the motor voltage input signal, providing an indication of how quickly the input is changing. An absolute value 2018 takes the absolute value of the input signal, in this case, the derivative of the motor voltage input 2012. A threshold value α, 2020, is used in the relational operator block 2022. It is compared with the absolute value of the derivative signal. A system output is generated at a system output block 2026.

The model 2000 is configured to minimize the error between the desired and actual water levels using a feedback control loop that adjusts the input voltage to the pumps based on real-time measurements and error calculations.

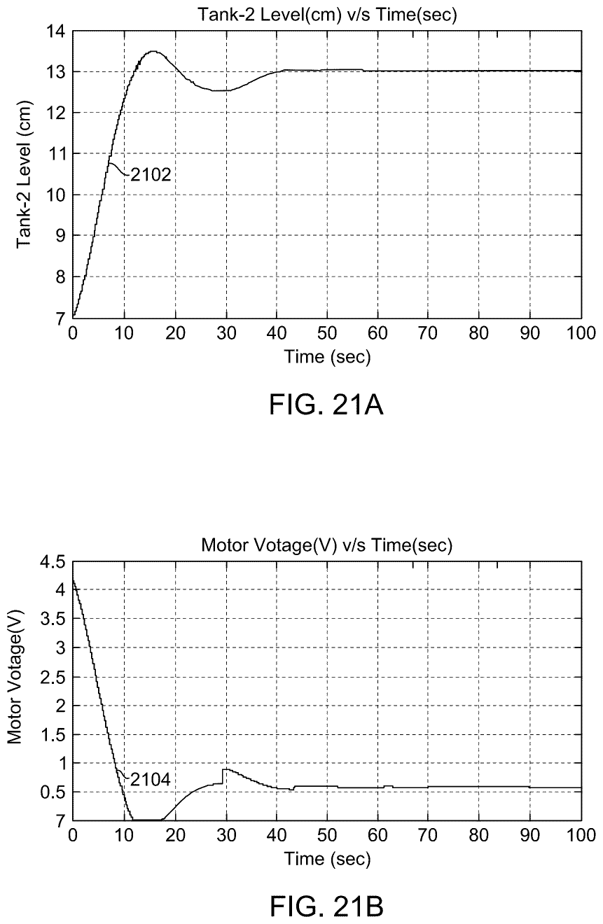

FIG. 21A illustrates the response of the tank level control system using the error cancellation control system of the present disclosure. The Y axis represents the tank level, denoted as Tank Level 2102, measured in millimeters (mm). The X axis represents time in seconds. The waveform 2102 shows the tank level starting from approximately 7 mm, rising steadily to a peak value just above 13 mm within the first 30 seconds. Subsequently, the tank level decreases slightly and stabilizes at around 12 mm. The graph demonstrates ability of the system to reach and maintain the desired tank level effectively, indicating the efficiency of the error cancellation controller in achieving rapid settling with minimal overshoot and steady-state error.

FIG. 21B depicts the motor voltage applied to the pump in the tank level control system using an error cancellation controller. The Y axis represents the motor voltage, denoted as motor voltage 2104, measured in volts (V). The X axis represents time in seconds. The waveform 2104 indicates an initial motor voltage of 4.5 V, which rapidly decreases to about 0.5 V within the first 20 seconds. After a brief period of fluctuation, the voltage stabilizes at a value slightly below 0.5 V, maintaining this level for the remainder of the observed period. The graph demonstrates capability of the controller to modulate the motor voltage effectively, ensuring a stable and precise control of the tank level.

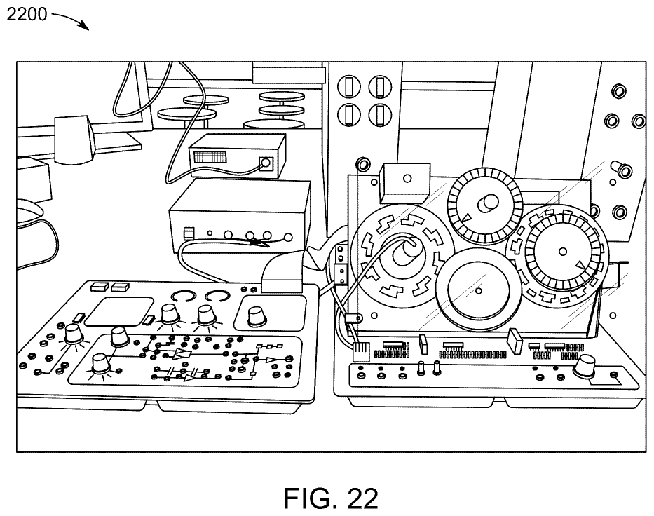

FIG. 22 shows the experimental setup 2200 used for testing the iterative error cancellation procedure, using a servo-trainer 33-110 manufactured by Feedback Inc., Crowborough, United Kingdom. The setup 2200 includes the Feedback Sample And Hold Unit SH150M. The system is used to introduce position errors in the position servo system through mis-calibration of the servo-amplifier and by injecting random step inputs. FIG. 22 illustrates the actual experimental apparatus, demonstrated the components used for implementing and testing the error cancellation procedure. The setup 2200 effectively demonstrates ability of the system to nearly cancel the introduced errors within one iteration.

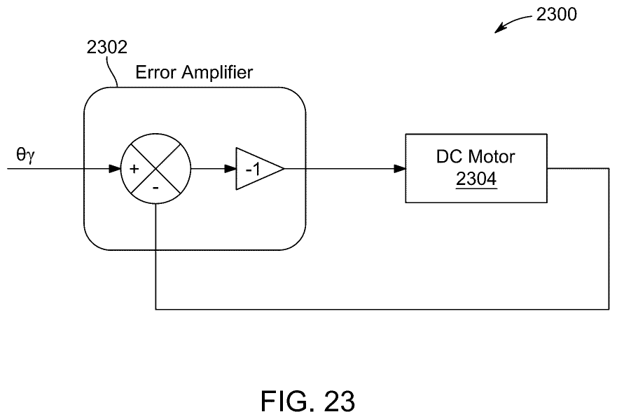

FIG. 23 presents the block diagram of the position control system 2300 used in the experimental setup. The system includes an error amplifier 2302 which processes the difference between the reference angle θr and the actual position feedback, generating a control signal that drives the DC motor 2304. The configuration illustrates the fundamental components and their interactions within the position control system, for testing the iterative error cancellation procedure. The steady state results are shown in Table 3.

TABLE 3
Data for position control system at no load

| θᵢₙ | θₒᵤₜ | Vₑᵣᵣₒᵣ X1 | V_{MechUnit} X2 |
|---|---|---|---|
| 0 | 0 | 49.26 mV | 24.45 mV |

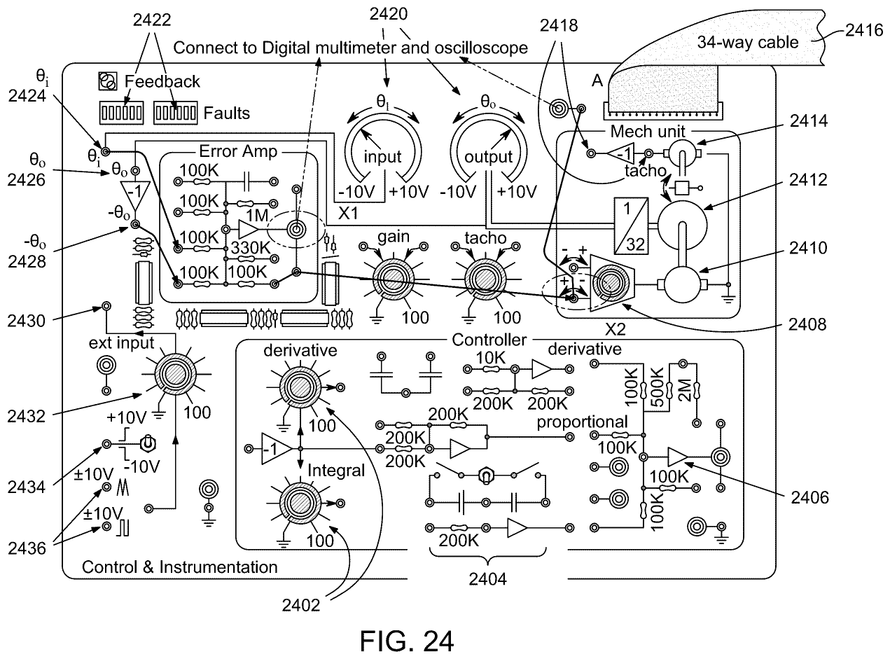

FIG. 24 illustrates a circuit connection diagram for the position control system. The layout showcases the interconnections and functionalities of various components involved in the position control of a servo mechanism.

The control panel comprises controller potentiometers 2402, which are essential for adjusting the control parameters to fine-tune response of the system. The controller amplifier networks 2404 are configured for the amplification of signals within the system, ensuring that the control signals are adequately boosted. The controller output amplifier 2406 further amplifies the control signals before they are fed into the servo motor 2410, which drives the servo mechanism.

The system includes a power amplifier and zero adjustment unit 2408, which is critical for calibrating the servo system to achieve accurate position control. The motor 2410 operates in conjunction with a brake disc 2412, providing mechanical resistance necessary for testing the performance of the servo system under various conditions. The tachogenerator 2414 generates feedback signals related to speed of the motor, which are significant for maintaining precise control over movement of the servo.

A 34-way cable 2416 facilitates the connection of various components within the system, ensuring seamless communication and signal transmission. Fault switches 2422 are incorporated to simulate faults within the system, allowing for comprehensive testing and troubleshooting. The input shaft angle signal 2424 and output shaft angle signal 2426 provide real-time data on the reference and feedback angles, respectively. Additionally, the inverted output shaft angle signal 2428 is used for specific control tests, enhancing versatility of the system.

The variable amplitude input to system 2430 allows for the adjustment of amplitude of the input signal, catering to different testing requirements. The external input signal potentiometer 2432 is used to modify the external input signal, providing flexibility in the testing process. The ±10V switched step signal 2434 supplies a stepped input signal, significant for testing response of the system to sudden changes. Test signals 2436 are employed for diagnostics and monitoring performance of the system.

FIG. 24 shows the connections and adjustments made during the testing process. Line X1 indicates the connection to a digital multimeter and oscilloscope, which are used for precise measurements and monitoring. Line X2 denotes the adjustment knob for the power amplifier, which is utilized to introduce an intentional error in the servo calibration, creating a deviation between the reference angle and the output angle of the servo shaft for testing purposes.

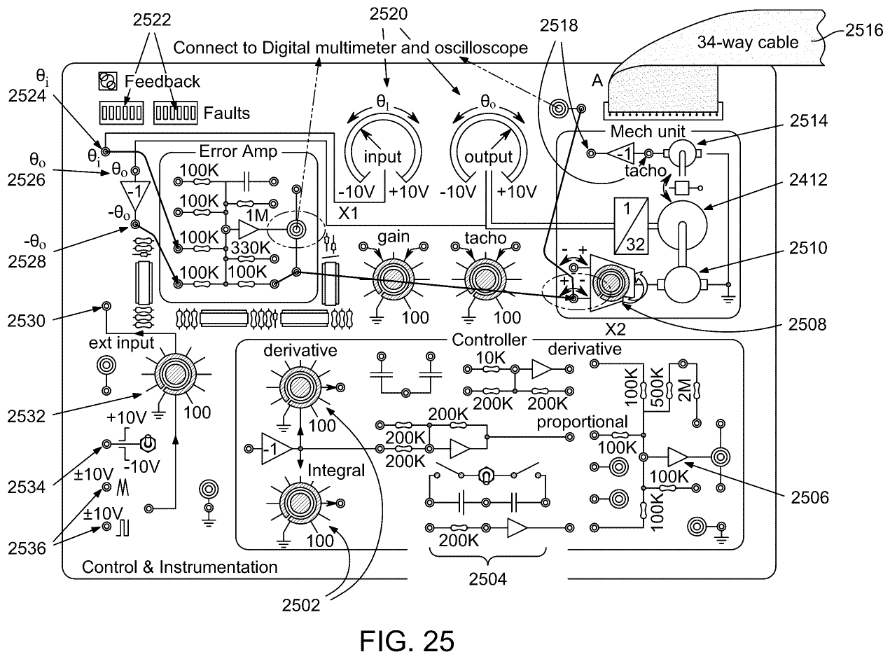

FIG. 25 is a circuit connection diagram for the position control system having error introduced in calibration explanation. The layout demonstrates the interconnections and functionalities of various components integral to the position control of the servo mechanism.

The control panel features controller potentiometers 2502, essential for adjusting control parameters and fine-tuning response of the system. Controller amplifier networks 2504 amplify signals within the system, ensuring adequate boosting of control signals. The controller output amplifier 2506 further enhances control signals before they reach the motor 2510, which drives the servo mechanism.

A power amplifier and zero adjustment unit 2508 is significant for calibrating the servo system to achieve precise position control. The motor 2510 operates with a brake disc 2512, providing necessary mechanical resistance to test performance of the system under various conditions. The tachogenerator 2514 generates feedback signals related to speed of the motor, maintaining precise control over movement of the servo. The tachogenerator signals 2518 provide feedback for the motor 2510. The potentiometers 2520 allow for precise adjustments of the system parameters.

A 34-way cable 2516 ensures seamless communication and signal transmission among the system components. Fault switches 2522 simulate faults within the system for comprehensive testing and troubleshooting. The input shaft angle signal 2524 and output shaft angle signal 2526 provide real-time data on reference and feedback angles, respectively. The inverted output shaft angle signal 2528 is used for specific control tests, enhancing system versatility.

The variable amplitude input to the system 2530 allows for the adjustment of amplitude of the input signal to cater to different testing requirements. The external input signal potentiometer 2532 modifies the external input signal, providing testing flexibility. The ±10V switched step signal 2534 supplies a stepped input signal, for testing response of the system to sudden changes. Test signals 2536 are employed for diagnostics and monitoring system performance.

In an example, a 20 degree error is created. The data for the position control system after introducing the 20 degree error in calibration is shown in Table 4.

TABLE 4
Data for position control system after error in calibration

| θᵢₙ | θₒᵤₜ | Vₑᵣᵣₒᵣ X1 | V_{MotorInput} X2 |
|---|---|---|---|
| 0 | +20 | −1.2373 | −1.2313 |

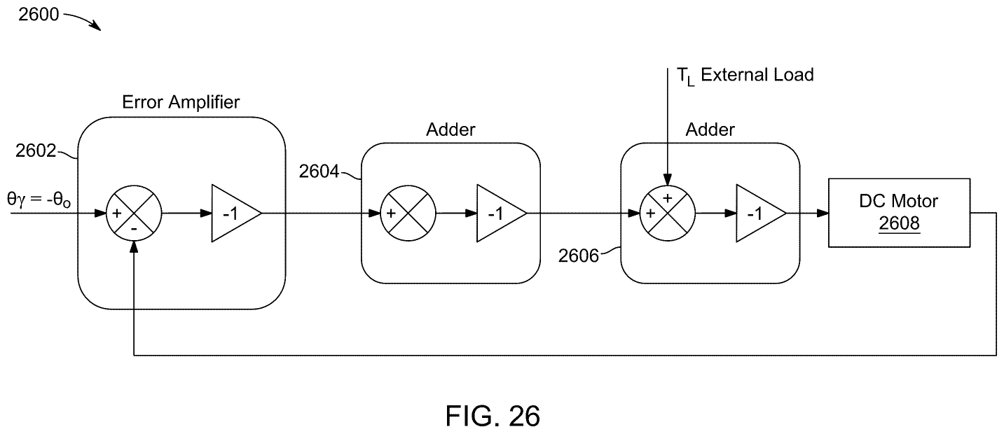

FIG. 26 illustrates a block diagram of the position control system with an external disturbance. The system comprises an error amplifier 2602 that processes the difference between the reference angle and the output angle, generating an amplified error signal. The error signal is then fed into a first adder 2604, which integrates the control input. The output of the first adder 2604 is subsequently processed by a second adder 2606, which incorporates the effect of an external load disturbance. Finally, the processed signal drives the DC motor 2608, which adjusts the position of the servo mechanism accordingly. The external load, represented as TL, introduces an additional torque, simulating real-world operational conditions.

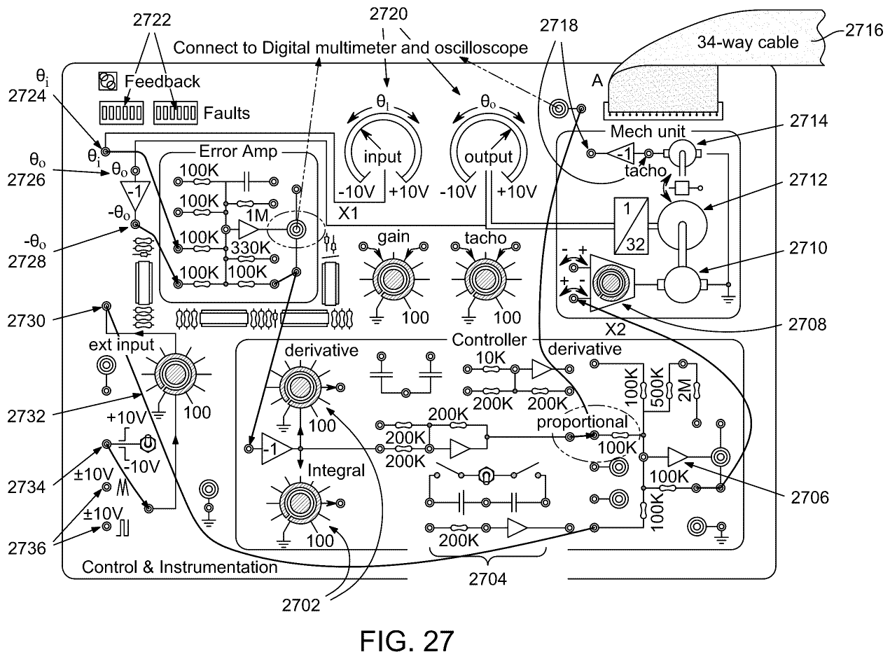

FIG. 27 presents the circuit connection for the position control system with an external disturbance. The layout includes controller potentiometers 2702, which are used to adjust the control parameters and fine-tune the response of the system. The controller amplifier networks 2704 amplify control signals within the system, ensuring that the control signals are adequately boosted before reaching the motor 2710. The controller output amplifier 2706 further enhances control signals before they reach the motor 2710, which drives the servo mechanism.

The power amplifier and zero adjustment unit 2708 is provided for calibrating the servo system to achieve precise position control. The motor 2710 operates with a brake disc 2712, providing necessary mechanical resistance to test performance of the system under various conditions. The tachogenerator 2714 generates feedback signals related to speed of the motor, which is essential for maintaining precise control over movement of the servo. The tachogenerator signals 2718 provide feedback for the motor 2710. The potentiometers 2720 allow for precise adjustments of the system parameters.

A 34-way cable 2716 ensures seamless communication and signal transmission among the system components. Fault switches 2722 simulate faults within the system for comprehensive testing and troubleshooting. Input shaft angle signal 2724 and output shaft angle signal 2726 provide real-time data on the reference and feedback angles, respectively. The inverted output shaft angle signal 2728 is used for specific control tests, enhancing system versatility. Variable amplitude input to the system 2730 allows for the adjustment of amplitude of the input signal, catering to different testing requirements. The external input signal potentiometer 2732 modifies the external input signal, providing flexibility during testing. The ±10V switched step signal 2734 supplies a stepped input signal, for testing response of the system to sudden changes. Test signals 2736 are employed for diagnostics and monitoring system performance.

The steady state results, for the position control system having external errors introduced, are shown in Table-5.

TABLE 5
Data for position control system after disturbance has occurred.

| θᵢₙ | θₒᵤₜ | Vₑᵣᵣₒᵣ X1 | V_{MotorInput} X2 | Mech Input Voltage |
|---|---|---|---|---|
| 0 | −68 | −3.94 V | −3.938 V | −1.2415 V |

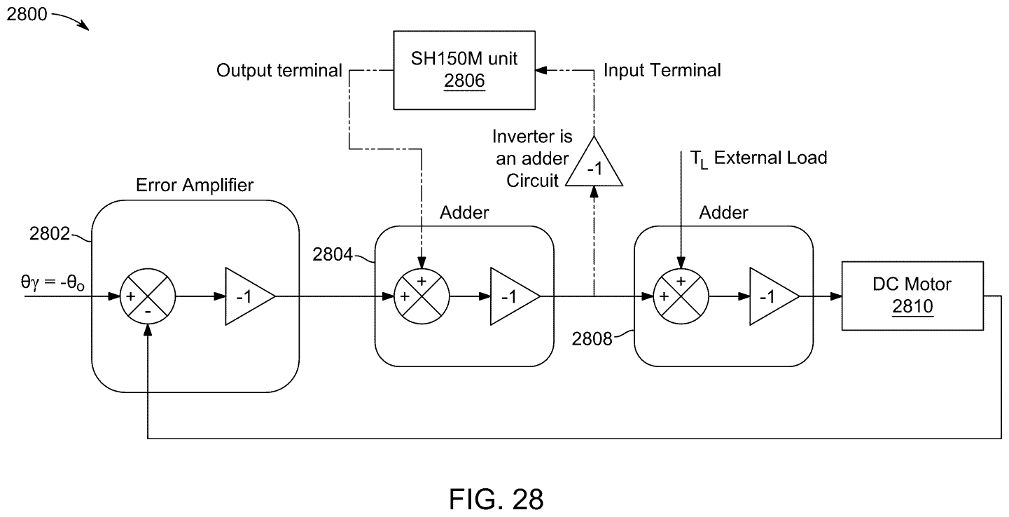

FIG. 28 illustrates a block diagram of the position control system incorporating the SH150M unit for implementing the iterative error cancellation procedure. The system includes an error amplifier 2802, which receives the input θr=−θo and amplifies the error signal. This amplified signal is then fed into a first adder circuit 2804. The first adder circuit 2804 also receives an input from the SH150M unit 2806, which provides the necessary hold function to maintain the signal during the processing cycle. The output of the first adder circuit 2804 is then passed through another amplification stage and directed to a second adder circuit 2808. The second adder circuit 2808 incorporates the external load disturbance TL and adjusts the control signal accordingly. The final output from the second adder circuit 2808 is used to drive the DC motor 2810, which actuates the system to achieve the desired position control. The SH150M unit 2806 is configured for the iterative error cancellation as it samples the error signal and holds it steady, allowing for precise adjustments in the control loop. The SH150M unit has internal, periodically triggered capabilities. In this example, the sample and hold circuit was used in the internal periodically triggered mode at 1 HZ to show that the suggested controller can operate in this mode.

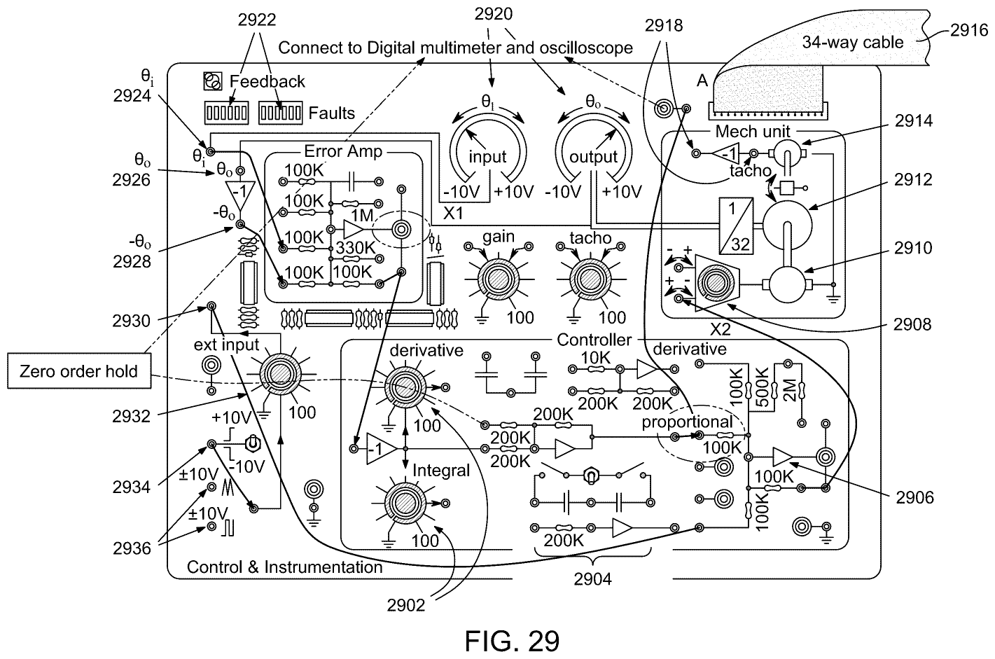

FIG. 29 illustrates the circuit connections for the position control system integrated with the stop and hold unit (for example, SH150M unit). The control and instrumentation section features various control knobs, including controller potentiometers 2902 and controller amplifier networks 2904. The error amplifier circuit 2906 processes the input shaft angle signal θi 2924 and the output shaft angle signal θo 2926, as well as the inverted output shaft angle signal 2928. The potentiometers 2920 allow for precise adjustments of the system parameters.

The tacho generator 2914 generates feedback signals related to the speed of the motor, which is essential for maintaining precise control over the movement of the servo. The tacho generator signals 2918, and the brake disc 2912 provide feedback for motor 2910. The power amplifier and zero adjustment section 2908 ensure that the motor receives the correct drive signal.

A 34-way cable 2916 ensures seamless communication and signal transmission among the system components. Fault switches 2922 simulate faults within the system for comprehensive testing and troubleshooting. The input shaft angle signal 2924 and output shaft angle signal 2926 provide real-time data on reference and feedback angles, respectively. The inverted output shaft angle signal 2928 is used for specific control tests, enhancing system versatility.

Variable amplitude input to the system 2930 allows for the adjustment of the amplitude of the input signal, catering to different testing requirements. The external input signal potentiometer 2932 and the ±10V switched step signal 2934 are used to inject disturbances and test signals into the system. The SH150M unit 2930, integrated into the feedback loop, samples the error signal at 1 Hz and holds it steady, enabling the iterative error cancellation procedure to effectively reduce position errors. The detailed connections between these components ensure that the system operates correctly and that the error cancellation procedure can be accurately implemented. Test signals 2936 are employed for diagnostics and monitoring system performance.

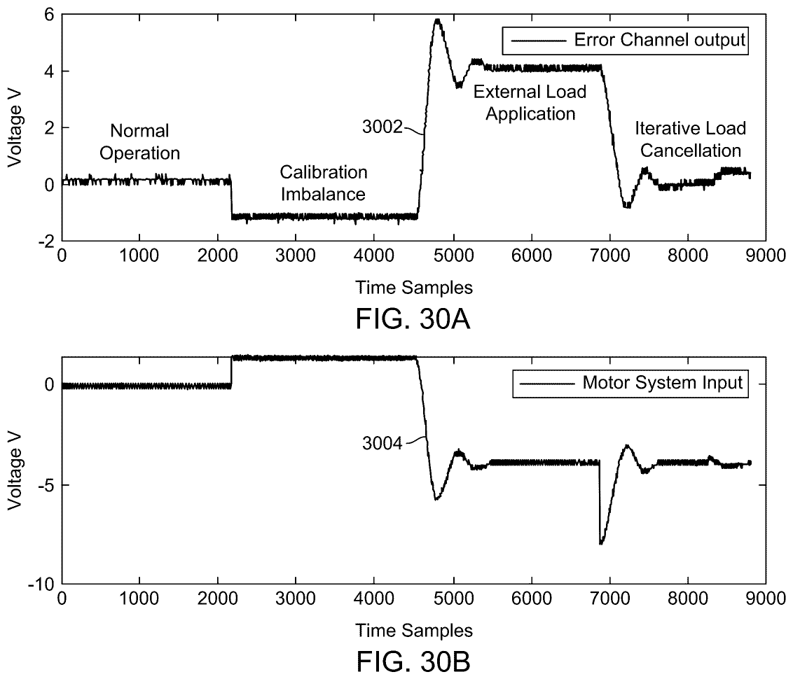

FIG. 30A and FIG. 30B depicts the error channel output and motor system input waveforms for different operational states, including normal operation, calibration imbalance, external load application, and iterative load cancellation. FIG. 30A illustrates the error channel output voltage, represented by curve 3002, over time samples, demonstrating the response to calibration imbalances and external load application. FIG. 30B displays the motor system input voltage, represented by curve 3004, over time samples. The curve 3004 indicates the variations in motor input in response to the introduced disturbances and the subsequent error cancellation achieved through the iterative procedure.

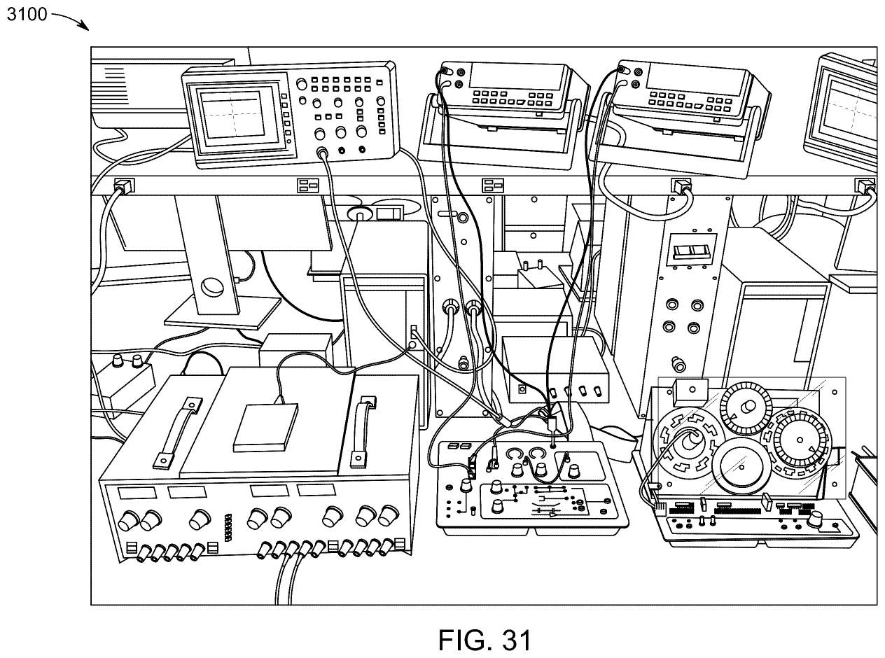

FIG. 31 depicts the testing bench and equipment setup 3100 used for evaluating the iterative error cancellation procedure applied to the speed control system of a servo motor. The setup 3100 includes various measurement instruments, such as oscilloscopes, power supplies, and signal generators, along with the servo trainer kit. The setup 3100 ensures accurate and reliable testing conditions for the speed control experiments, allowing for precise data acquisition and analysis.

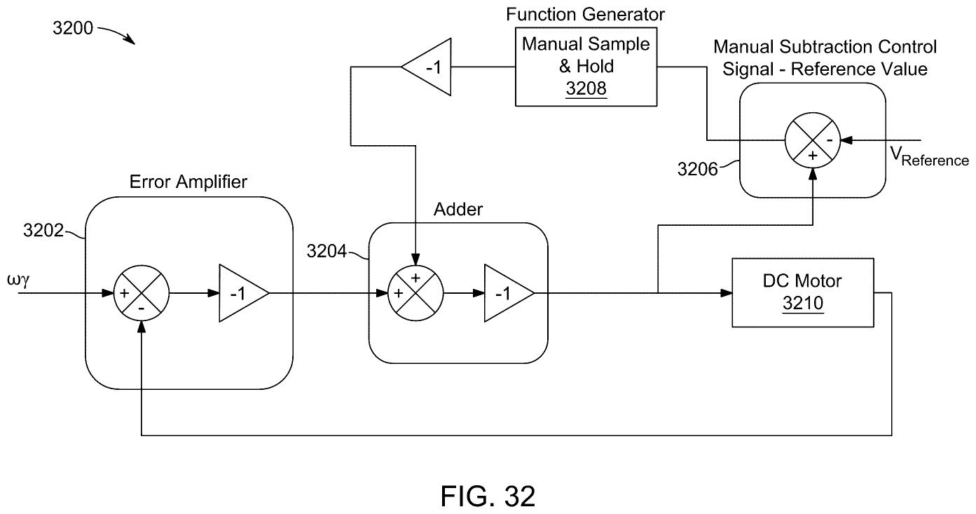

FIG. 32 illustrates a block diagram of a control system 3200 designed to manage the speed of a DC motor 3210 using a manual sample and hold circuit 3208. The control system 3200 of this example is a single loop (SISO) system. Each error control loop of the decentralised controller of FIG. 6 includes an adder 3204 connected to the amplifier 3202 and the sample and hold circuit 3208. The adder is configured to add the amplified error signals Kᵢ·uᵢ(t) to the steady state error cancellation signal Z(t)ᵢ and generate the steady state control signals uᵢ(t).

The system 3200 begins with an error amplifier 3202, which receives an input signal representing the reference speed ωᵣ. The error amplifier 3202 computes the difference between the reference speed ωᵣ and the actual speed feedback from the DC motor 3210, generating an error signal.

The error signal or is then processed by an adder 3204, which sums the error signal or with other input signals to provide a composite control signal.

The composite control signal is then fed to a manual subtraction process, where the control signal is adjusted by subtracting a reference value V_{reference}. The adjusted signal is then fed to a manual sample and hold circuit 3208. The manual sample and hold circuit 3208, controlled by a function generator, periodically samples the composite control signal and holds the value steady for a defined period, thereby stabilizing the control action.

The output of the manual sample and hold circuit 3208 is then subjected to the composite control signal. The control signal is then applied to the input of the DC motor 3210, thereby controlling its speed.

The feedback loop is completed as the output from the DC motor 3210 is fed back into the error amplifier 3202, enabling continuous monitoring and adjustment of the motor speed to maintain it at the desired reference value. The system depicted in FIG. 32 ensures precise control of the DC motor speed through the use of a manual sample and hold circuit 3206, providing robustness against transient fluctuations and maintaining steady-state performance.

The nature of the speed control makes it necessary for the motor to have a finite voltage input for it to run. Unlike position control, if the input to the motor is zero, the motor will not run. The circuit needed to properly compute the error voltage that needs to be injected to cancel steady state error in a speed servo is not an easy one to construct. Therefore, in this example, the computations needed by the controller and the triggering of the sample and hold circuit were performed manually without a triggering circuit. This may be considered as an advantage of the suggested controller in the sense that the controller will still work even if the triggering is manually conducted.

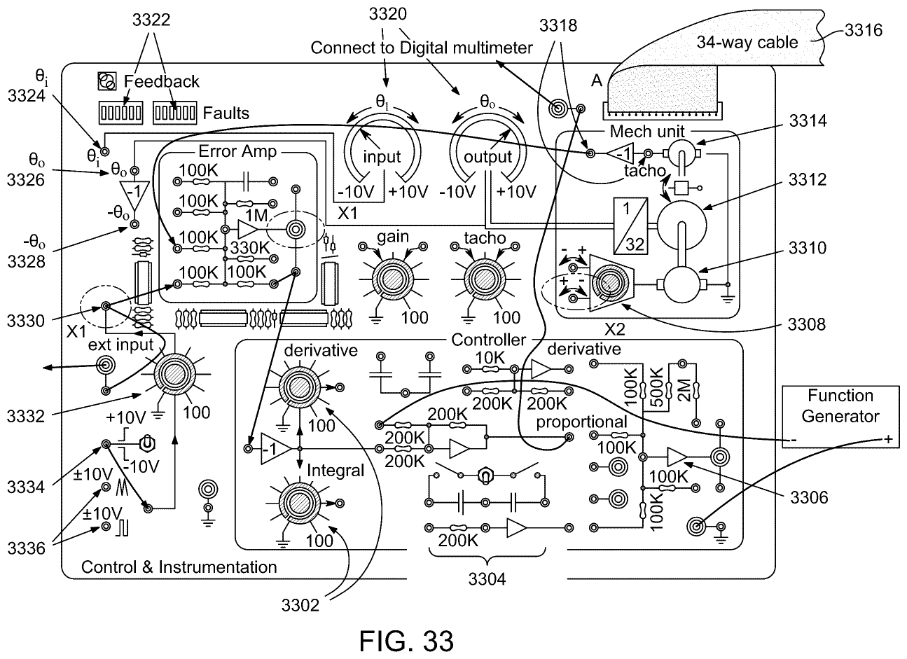

FIG. 33 illustrates a circuit connection diagram for a speed control system including the manual sample and hold circuit. Controller potentiometers 3302 are integral for adjusting control parameters, ensuring response of the system is finely tuned. The controller amplifier networks 3304 is configured for amplifying the signals within the system, thereby providing the necessary signal boost. The controller output amplifier 3306 further amplifies these signals before they reach the motor 3310, for driving the servo mechanism.

A power amplifier and zero adjustment unit 3308 is configured for calibrating the servo system to achieve precise position control. The motor 3310 is coupled with a brake disc 3312, offering the required mechanical resistance to evaluate system performance under various conditions. The tachogenerator 3314 generates feedback signals corresponding to speed of the motor, facilitating precise control over movement of the servo. These tachogenerator signals 3318 provide essential feedback for motor 3310.

Potentiometers 3320 allow for precise adjustments of the system parameters, ensuring accurate tuning of the control system. The 34-way cable 3316 ensures seamless communication and signal transmission among various components of the system. Fault switches 3322 are employed to simulate faults within the system, enabling comprehensive testing and troubleshooting. The input shaft angle signal 3324 and output shaft angle signal 3326 provide real-time data on the reference and feedback angles, respectively. An inverted output shaft angle signal 3328 is used for specific control tests, enhancing performance of the system.

The variable amplitude input to the system 3330 allows for the adjustment of amplitude of the input signal to meet different testing requirements. The external input signal potentiometer 3332 modifies the external input signal, adding flexibility to the testing process. A ±10V switched step signal 3334 supplies a stepped input signal, essential for testing response of the system to sudden changes. Test signals 3336 are employed for diagnostics and to monitor performance of the system, ensuring reliable and accurate control.

In one example, at no load, the input to the servo is adjusted so that at a speed of 30 rpm is obtained, and data is shown in Table 6.

TABLE 6
Data Acquired for Speed Control System at No load.

| | | Output of error channel - Input to |
|---|---|---|
| Speed w rpm | Input Voltage X1 | Servo Motor Voltage X2 |
| 30 | 5.473 V | −2.8 V |

The magnetic brake is then applied at full load reducing the speed to 22.9 rpm, and data is shown in Table 7.

TABLE 7
Data Acquired for Speed Control System at Full load

| Speed w rpm | Input Voltage X1 | Input to Servo Motor Voltage X2 |
|---|---|---|
| 22.9 | 5.473 | −3.453 |

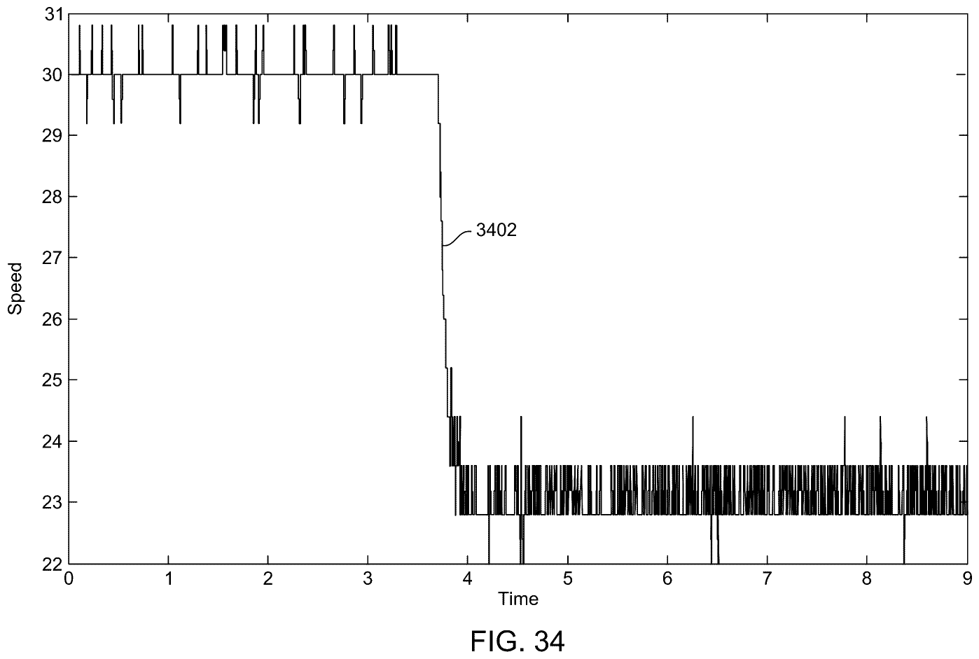

FIG. 34 illustrates a graphical representation of the drop in servo-motor speed in revolutions per minute (RPM) due to the sudden application of load torque. The graph plots the motor speed over time, waveform 3402 represents the impact of the applied load and the subsequent recovery of the motor speed as the iterative error cancellation procedure is applied.

The error injected into the control input is computed according to Equation (17), where the reference voltage is the voltage feeding the motor at no load when speed of the motor is at the desired speed.

$${V}_{FinalValue} - \vert {V}_{reference} \vert = {V}_{addedDifference} \qquad ( 17 )$$

The results at different iterations are shown in Table-8 below. The error was almost totally cancelled in 11 iterations.

TABLE 8
Data Acquired for Speed Control System
at Full load with Manual S&H.

| | V input to the | | speed | Error channel |
|---|---|---|---|---|
| Iteration | servo motor | Difference | rpm | Voltage |
| 1 | 3.453 | 0.65 | 25.3 | −3.28 |
| 2 | 3.899 | 1.10 | 27 | −3.12 |
| 3 | 4.2 | 1.40 | 28.2 | −3.02 |
| 4 | 4.41 | 1.61 | 28.9 | −2.95 |
| 5 | 4.555 | 1.76 | 29.4 | −2.89 |
| 6 | 4.653 | 1.85 | 29.8 | −2.87 |
| 7 | 4.72 | 1.92 | 30 | −2.85 |
| 8 | 4.772 | 1.97 | 30.2 | −2.83 |
| 9 | 4.81 | 2.01 | 30.3 | −2.81 |
| 10 | 4.845 | 2.05 | 30.4 | −2.8 |
| 11 | 4.87 | 2.07 | 30.4 | −2.8 |

The first embodiment is illustrated with respect to FIG. 6, FIG. 7 and FIG. 35 to FIG. 38. The first embodiment describes a decentralized controller 600 for steady state error cancellation in a plant system having N components, which includes an error control loop for each component i of the N components. Each error control loop includes steady state control signals uᵢ(t) and plant output signals Xᵢ(t).

Each error control loop includes a first multiplier 601 configured to receive a set point value Rᵢ and the plant output signals Xᵢ(t), multiply the set point value Rᵢ by a negative value of the plant output signals Xᵢ(t) and generate error signals eᵢ(t) and an amplifier 602 connected to an output terminal of the first multiplier 601, wherein the amplifier 602 is configured to amplify the error signals eᵢ(t) by a gain Kᵢ and generate amplified error control signals Kᵢ·uᵢ(t). Each error control loop further includes a trigger circuit 604 connected to the output terminal of the first multiplier 601. The trigger circuit 604 is configured to receive the error signals eᵢ(t), detect a steady state event of the error signals and generate a trigger pulse gᵢ(t) based on detecting the steady state event. Each error control loop further includes a sample and hold circuit 606 is configured to receive the trigger pulse gᵢ(t) and negative values of the steady state control signals uᵢ(t), generate a steady state error cancellation signal Z(t)ᵢ and inject the steady state error cancellation signal Z(t)ᵢ into the error control loop.

In an aspect, the decentralized controller 600 further includes, for each error control loop, a first feedback loop configured to transmit the steady state control signals uᵢ(t) to the sample and hold circuit 606, and a second feedback loop configured to transmit negative values of the plant output signals Xᵢ(t) to the first multiplier 601.

In an aspect, the decentralized controller 600 further includes, for each error control loop, an adder connected to the amplifier 602 and the sample and hold circuit 606. The adder is configured to add the amplified error signals Kᵢ·uᵢ(t) to the steady state error cancellation signal Z(t)ᵢ and generate the steady state control signals uᵢ(t).

In an aspect, the steady state error cancellation signal Z(t)ᵢ is given by: Z(t)ᵢ=usᵢ(tⱼ)·Φ(t −tⱼ), where usᵢ(tⱼ) is an estimate of a steady state value of an i^{th} steady state control signal at an instant tⱼ at which a steady state is reached after the injection of the steady state error control signal uᵢ(tⱼ₋₁) at a previous instant tⱼ₋₁, where Φ(t−tⱼ) is a unit step function.

In an aspect, the trigger circuit 604 for each error control loop includes a high pass filter configured to receive the error signals eᵢ(t) and generate high pass filtered error signals S1.

In an aspect, the trigger circuit 604 for each error control loop includes a non-linearity detector configured to receive each high pass filtered error signal S1, compare an absolute value of the high pass filtered error signal S1 to a non-linearity threshold value δ and generate transformed signals S2 including one of a positive unity signal S2⁺ and a negative unity signal S2⁻ based on the absolute value of the high pass filtered error signal S1 being greater and less than or equal to than the non-linearity threshold value δ respectively.

In an aspect, the non-linearity threshold value δ is greater than zero and less than one.

In an aspect, the non-linearity threshold value δ is a programmable value selected from one of a set consisting of 0.005, 0.01, 0.02 and 0.25.

In an aspect, the trigger circuit 604 for each error control loop further includes an integrator configured to receive the transformed signals S2, integrate the transformed signals S2 over a time interval and generate an error duration signal S3.

In an aspect, the trigger circuit 604 for each error control loop further includes a second multiplier configured to receive the error duration signal S3, multiply the error duration signal S3 by a guard margin value Tₜₕ and generate time limited error duration signals S4.

In an aspect, the trigger circuit 604 for each error control loop further includes a sign detector configured to receive the time limited error duration signals S4 and generate one of a positive unity pulse S5⁺ when each time limited error duration signal S4 is greater than zero and a negative unity pulse S5⁻ when each time limited error duration signal S4 is less than or equal to zero.

In an aspect, the sign detector is further configured to detect the steady state event of the error signals when a negative unity pulse S5⁻ transitions to a positive unity pulse S5⁺, and transmit the positive unity pulse to the positive edge triggered circuit upon detecting the transition to the positive unity pulse S5⁺.

In an aspect, the trigger circuit 604 for each error control loop further includes a positive edge-triggered circuit connected to the sign detector. The positive edge-triggered circuit is configured to generate a trigger pulse gᵢ(t) upon receiving the positive unity pulse S5⁺.

In an aspect, the trigger circuit 604 for each error control loop further includes a reset loop configured to transmit the trigger pulse gᵢ(t) to the integrator. The trigger pulse is configured to reset the integrator to zero to avoid integrator wind-up.

The second embodiment is illustrated with respect to FIG. 6, FIG. 7 and FIG. 35 to FIG. 38. A method for cancelling steady state error in a plant system having N components includes establishing an error control loop for each component i of the N components. Each error control loop includes steady state control signals uᵢ(t) and plant output signals Xᵢ(t). The method further includes performing steady state error cancellation in each error control loop.

The step of performing steady state error cancellation includes receiving, by a first multiplier 601, a set point value Rᵢ and the plant output signals Xᵢ(t), multiplying the set point value Rᵢ by a negative value of the plant output signals Xᵢ(t) and generating error signals eᵢ(t), amplifying, with an amplifier 602 connected to an output terminal of the first multiplier 601, the error signals eᵢ(t) by a gain Kᵢ and generating the amplified error control signals Kᵢ·uᵢ(t), and receiving, by a trigger circuit 604 connected to the output terminal of the first multiplier 601, the error signals eᵢ(t). The step of performing steady state error cancellation further includes detecting, by the trigger circuit, a steady state event of the error signals, generating by the trigger circuit, a trigger pulse gᵢ(t) based on detecting the steady state event, receiving, by a sample and hold circuit connected to the trigger circuit, the trigger pulse gᵢ(t) and negative values of the steady state control signals uᵢ(t), generating, by the sample and hold circuit, a steady state error cancellation signal Z(t)_{I}, and injecting, by the sample and hold circuit, the steady state error cancellation signal Z(t)ᵢ into the error control loop.

In an aspect, the method, for each error control loop, includes summing, by an adder connected to the amplifier 602 and the sample and hold circuit, the amplified error signals Kᵢ·uᵢ(t) with the steady state error cancellation signal Z(t)ᵢ and generating the steady state control signals uᵢ(t).

In an aspect, detecting the steady state event of the error signals by the trigger circuit 604 further includes integrating, with an integrator, the transformed signals S2 over a time interval and generating an error duration signal S3, receiving, by a second multiplier, the error duration signal S3, receiving, by the second multiplier, by a guard margin value Tₜₕ, and multiplying, by the second multiplier, the error duration signal S3 by the guard margin value Tₜₕ and generating time limited error duration signals S4.

In an aspect, detecting the steady state event of the error signals by the trigger circuit 604 further includes receiving, by a sign detector, the time limited error duration signals S4, generating, by the sign detector, one of a positive unity pulse S5⁺ when each time limited error duration signal S4 is greater than zero and a negative unity pulse S5⁻ when each time limited error duration signal S4 is less than or equal to zero. The step of detecting further includes detecting, by the sign detector, the steady state event of the error signals when a negative unity pulse S5⁻ transitions to a positive unity pulse S5⁺, transmitting the positive unity pulse to a positive edge triggered circuit upon detecting the transition to the positive unity pulse S5⁺, and generating, by the positive edge-triggered circuit, the trigger pulse gᵢ(t) upon receiving the positive unity pulse S5⁺.

In an aspect, the method further includes transmitting the trigger pulse gᵢ(t) to the integrator and eliminating integrator wind-up by resetting the integrator to zero with the trigger pulse gᵢ(t).

In another exemplary embodiment, a method for performing steady state error cancellation in a plant system having N components includes establishing an error control loop for each component i of the N components. Each error control loop includes steady state control signals uᵢ(t) and plant output signals Xᵢ(t). The method further includes performing steady state error cancellation in each error control loop.

The step of performing steady state error cancellation includes receiving, by a first multiplier 601, a set point value Rᵢ and the plant output signals Xᵢ(t), multiplying the set point value Rᵢ by a negative value of the plant output signals Xᵢ(t) and generating error signals eᵢ(t), amplifying, with an amplifier 602 connected to an output terminal of the first multiplier 601, the error signals eᵢ(t) by a gain Kᵢ and generating the amplified error control signals Kᵢ·uᵢ(t), receiving, by a trigger circuit 604 connected to the output terminal of the first multiplier 601, the error signals eᵢ(t), detecting, by the trigger circuit, a steady state event of the error signals. The step of performing steady state error cancellation further includes generating by the trigger circuit, a trigger pulse gᵢ(t) based on detecting the steady state event, receiving, by a sample and hold circuit connected to the trigger circuit, the trigger pulse gᵢ(t) and negative values of the steady state control signals uᵢ(t), generating, by the sample and hold circuit, a steady state error cancellation signal Z(t)_{I}, injecting, by the sample and hold circuit, the steady state error cancellation signal Z(t)ᵢ into the error control loop, and summing, by an adder connected to the amplifier 602 and the sample and hold circuit, the amplified error signals Kᵢ·uᵢ(t) with the steady state error cancellation signal Z(t)ᵢ and generating the steady state control signals uᵢ(t).

The method further includes detecting the steady state event of the error signals by the trigger circuit. The step of detecting includes integrating, with an integrator, the transformed signals S2 over a time interval and generating an error duration signal S3, receiving, by a second multiplier, the error duration signal S3, receiving, by the second multiplier, by a guard margin value Tₜₕ, multiplying, by the second multiplier, the error duration signal S3 by the guard margin value Tₜₕ and generating time limited error duration signals S4, receiving, by a sign detector, the time limited error duration signals S4, and generating, by the sign detector, one of a positive unity pulse S5⁺ when each time limited error duration signal S4 is greater than zero and a negative unity pulse S5⁻ when each time limited error duration signal S4 is less than or equal to zero. The step of detecting further includes detecting, by the sign detector, the steady state event of the error signals when a negative unity pulse S5⁻ transitions to a positive unity pulse S5⁺, transmitting the positive unity pulse to a positive edge triggered circuit upon detecting the transition to the positive unity pulse S5⁺, generating, by the positive edge-triggered circuit, the trigger pulse gᵢ(t) upon receiving the positive unity pulse S5⁺, transmitting the trigger pulse gᵢ(t) to the integrator, and eliminating integrator wind-up by resetting the integrator to zero with the trigger pulse gᵢ(t).

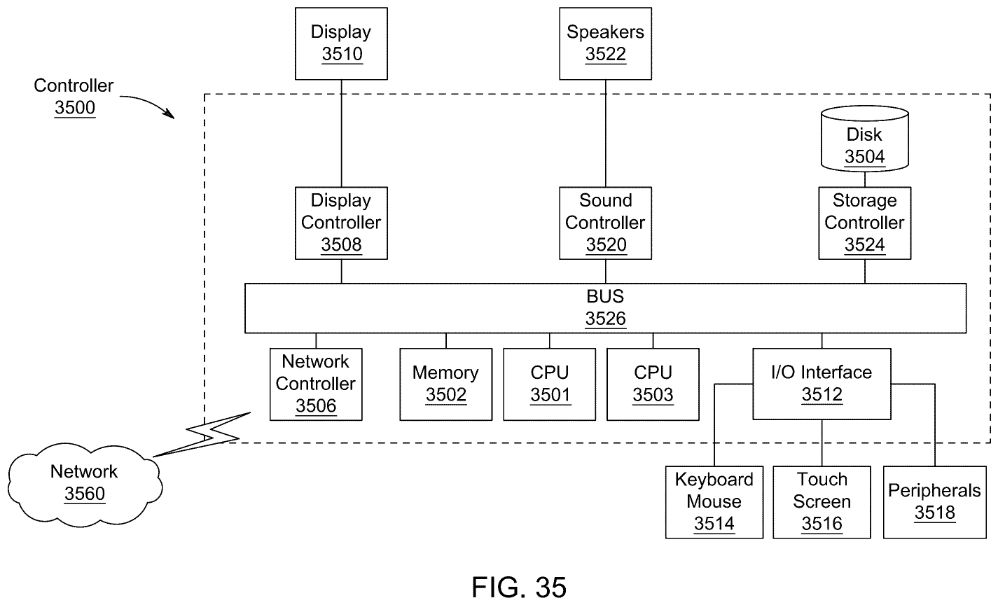

Next, further details of the hardware description of the computing environment according to exemplary embodiments is described with reference to FIG. 35. In FIG. 35, a controller 3500 is described as representative of the controller 600 of FIG. 6 in which the controller is a computing device which includes a CPU 3501 which performs the processes described above/below. The process data and instructions may be stored in memory 3502. These processes and instructions may also be stored on a storage medium disk 3504 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 3501, 3503 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 3501 or CPU 3503 may be a Xenon or Core processor from Intel of America or an Opteron processor from AMD of America, or may be other processor types that would be recognized by one of ordinary skill in the art. Alternatively, the CPU 3501, 3503 may be implemented on an FPGA, ASIC, PLD or using discrete logic circuits, as one of ordinary skill in the art would recognize. Further, CPU 3501, 3503 may be implemented as multiple processors cooperatively working in parallel to perform the instructions of the inventive processes described above.

The computing device in FIG. 35 also includes a network controller 3506, such as an Intel Ethernet PRO network interface card from Intel Corporation of America, for interfacing with network 3560. As can be appreciated, the network 3560 can be a public network, such as the Internet, or a private network such as an LAN or WAN network, or any combination thereof and can also include PSTN or ISDN sub-networks. The network 3560 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 3508, such as a NVIDIA GeForce GTX or Quadro graphics adaptor from NVIDIA Corporation of America for interfacing with display 3510, such as a Hewlett Packard HPL2445w LCD monitor. A general purpose I/O interface 3512 interfaces with a keyboard and/or mouse 3514 as well as a touch screen panel 3516 on or separate from display 3510. General purpose I/O interface also connects to a variety of peripherals 3518 including printers and scanners, such as an OfficeJet or DeskJet from Hewlett Packard.

A sound controller 3520 is also provided in the computing device such as Sound Blaster X-Fi Titanium from Creative, to interface with speakers/microphone 3522 thereby providing sounds and/or music.

The general purpose storage controller 3524 connects the storage medium disk 3504 with communication bus 3526, which may be an ISA, EISA, VESA, PCI, or similar, for interconnecting all of the components of the computing device. A description of the general features and functionality of the display 3510, keyboard and/or mouse 3514, as well as the display controller 3508, storage controller 3524, network controller 3506, sound controller 3520, and general purpose I/O interface 3512 is omitted herein for brevity as these features are known.

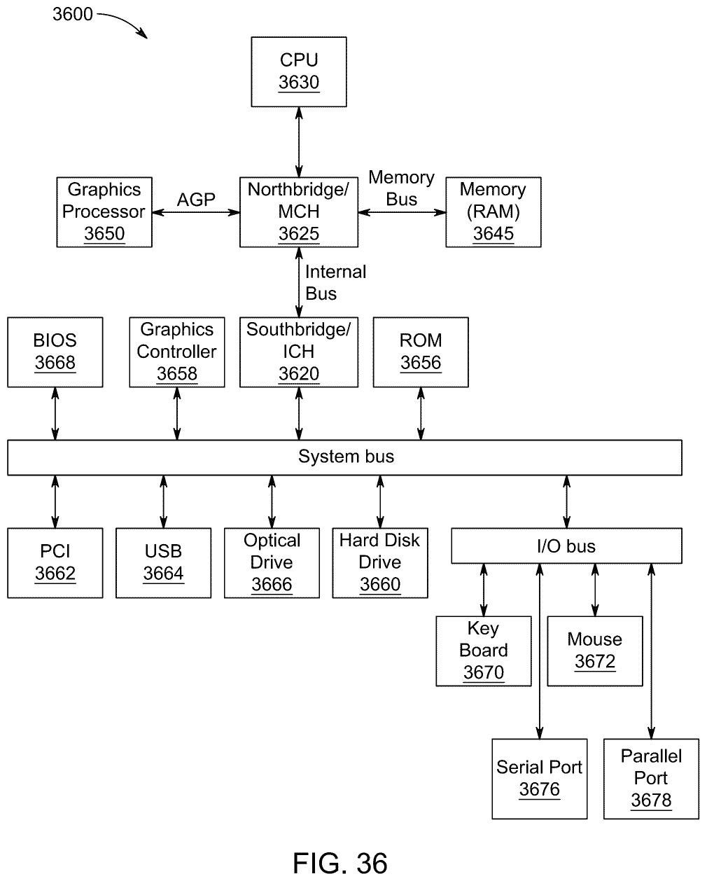

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 36.

FIG. 36 illustrates a schematic diagram of a data processing system, according to certain embodiments, for performing the functions of the exemplary embodiments. The data processing system is an example of a computer in which code or instructions implementing the processes of the illustrative embodiments may be located.

In FIG. 36, data processing system 3600 employs a hub architecture including a north bridge and memory controller hub (NB/MCH) 3625 and a south bridge and input/output (I/O) controller hub (SB/ICH) 3620. The central processing unit (CPU) 3630 is connected to NB/MCH 3625. The NB/MCH 3625 also connects to the memory 3645 via a memory bus, and connects to the graphics processor 3650 via an accelerated graphics port (AGP). The NB/MCH 3625 also connects to the SB/ICH 3620 via an internal bus (e.g., a unified media interface or a direct media interface). The CPU Processing unit 3630 may contain one or more processors and even may be implemented using one or more heterogeneous processor systems.

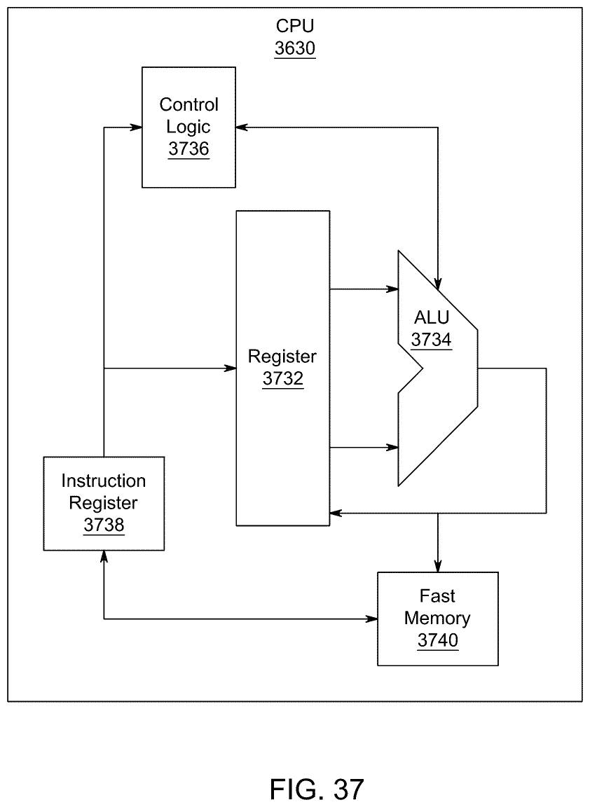

For example, FIG. 37 shows one implementation of CPU 3630. In one implementation, the instruction register 3738 retrieves instructions from the fast memory 3740. At least part of these instructions are fetched from the instruction register 3738 by the control logic 3736 and interpreted according to the instruction set architecture of the CPU 3630. Part of the instructions can also be directed to the register 3732. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 3734 that loads values from the register 3732 and performs logical and mathematical operations on the loaded values according to the instructions. The results from these operations can be feedback into the register and/or stored in the fast memory 3740. According to certain implementations, the instruction set architecture of the CPU 3630 can use a reduced instruction set architecture, a complex instruction set architecture, a vector processor architecture, a very large instruction word architecture. Furthermore, the CPU 3630 can be based on the Von Neuman model or the Harvard model. The CPU 3630 can be a digital signal processor, an FPGA, an ASIC, a PLA, a PLD, or a CPLD. Further, the CPU 3630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 36, the data processing system 3600 can include that the SB/ICH 3620 is coupled through a system bus to an I/O Bus, a read only memory (ROM) 3656, universal serial bus (USB) port 3664, a flash binary input/output system (BIOS) 3668, and a graphics controller 3658. PCI/PCIe devices can also be coupled to SB/ICH 3688 through a PCI bus 3662.

The PCI devices may include, for example, Ethernet adapters, add-in cards, and PC cards for notebook computers. The Hard disk drive 3660 and CD-ROM 3666 can use, for example, an integrated drive electronics (IDE) or serial advanced technology attachment (SATA) interface. In one implementation the I/O bus can include a super I/O (SIO) device.

Further, the hard disk drive (HDD) 3660 and optical drive 3666 can also be coupled to the SB/ICH 3620 through a system bus. In one implementation, a keyboard 3670, a mouse 3672, a parallel port 3678, and a serial port 3676 can be connected to the system bus through the I/O bus. Other peripherals and devices that can be connected to the SB/ICH 3620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

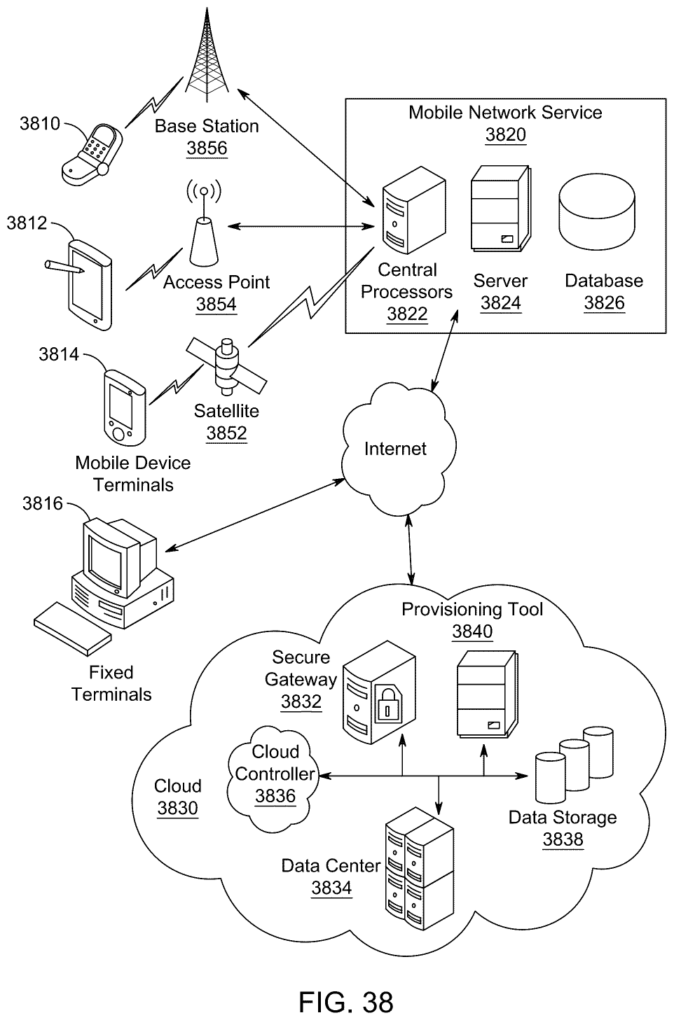

The functions and features described herein may also be executed by various distributed components of a system. For example, one or more processors may execute these system functions, wherein the processors are distributed across multiple components communicating in a network. The distributed components may include one or more client and server machines, such as cloud 3830 including a cloud controller 3836, a secure gateway 3832, a data center 3834, data storage 3838 and a provisioning tool 3840, and mobile network services 3820 including central processors 3822, a server 3824 and a database 3826, which may share processing, as shown by FIG. 38, in addition to various human interface and communication devices (e.g., display monitors 3816, smart phones 3838, tablets 3812, personal digital assistants (PDAs) 3814). The network may be a private network, such as a LAN, satellite 3852 or WAN 3854, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An industrial plant system having N interconnected industrial processes, comprising:
N actuators, each actuator operating to actuate one industrial process of the N interconnected industrial processes, each actuator being a control valve, an electrical actuator, or a piezoelectric actuator;
N sensors, each sensor sensing an output signal from one industrial process of the N interconnected industrial processes; and
a decentralized controller with steady state error cancellation, the decentralized controller providing steady state control signals to the N actuators, so as to control the N interconnected industrial processes, wherein:
the decentralized controller comprises N error control loops,
each actuator of the N actuators is controlled by one corresponding error control loop of the N error control loops, and
for an i-th actuator, with i=1, 2, . . . , N,
a corresponding i-th error control loop obtains a set point value Rᵢ assigned to the i-th actuator, acquires an output signal Xᵢ(t) from an i-th sensor, which senses the output signal Xᵢ(t) from an i-th industrial process, and applies a steady state control signal uᵢ(t) to the i-th actuator, such that the i-th actuator operates at an operating condition specified by the set point value Rᵢ,
the i-th error control loop further includes a first multiplier, an amplifier, a trigger circuit, a sample and hold circuit, and an adder,
the first multiplier is configured to: obtain the set point value Rᵢ, acquire the output signal Xᵢ(t), and multiply the set point value Rᵢ by a negative value of the output signal Xᵢ(t) to generate an error signal eᵢ(t),
the amplifier is connected to an output terminal of the first multiplier and configured to: amplify the error signal eᵢ(t) by a gain Kᵢ, and generate an amplified error control signal Kᵢ·eᵢ(t),
the trigger circuit is connected to the output terminal of the first multiplier and configured to: receive the error signals eᵢ(t), detect a steady state event of the error signals eᵢ(t), and generate a trigger pulse gᵢ(t) based on detecting the steady state event,
the sample and hold circuit is configured to; receive the trigger pulse gᵢ(t) from the trigger circuit, the steady state control signals uᵢ(t) from the adder, generate a steady state error cancellation signal Z(t)ᵢ based on the trigger pulse gᵢ(t) and a negative value of the steady state control signal uᵢ(t), and inject the steady state error cancellation signal Z(t)ᵢ into the adder, and
the adder is configured to: add the amplified error signals Kᵢ·eᵢ(t) and the steady state error cancellation signal Z(t)ᵢ to generate the steady state control signals uᵢ(t), and apply the steady state control signals uᵢ(t) to the i-th actuator to control operation thereof.

2. The industrial plant system of claim 1, the i-th error control loop further comprises:
a first feedback loop configured to transmit the steady state control signal uᵢ(t) to the sample and hold circuit; and
a second feedback loop configured to transmit the negative value of the output signal Xᵢ(t) to the first multiplier.

3. The industrial plant system of claim 1, wherein the steady state error cancellation signal Z(t)ᵢ is given by: Z(t)ᵢ=usᵢ(tⱼ)·Φ(t−tⱼ), where usᵢ(tⱼ) is an estimate of a steady state value of an i^{th} steady state control signal at an instant tⱼ at which a steady state is reached after the injection of the steady state error control signal uᵢ(tⱼ₋₁) at a previous instant tⱼ₋₁, where Φ(t−tⱼ) is a unit step function.

4. The industrial plant system of claim 1, wherein the trigger circuit further comprises:
a high pass filter configured to receive the error signal eᵢ(t) and generate a high pass filtered error signal S1.

5. The industrial plant system of claim 4, wherein the trigger circuit further comprises:
a non-linearity detector configured to receive the high pass filtered error signal S1, compare an absolute value of the high pass filtered error signal S1 to a non-linearity threshold value δ and generate a transformed signal S2 comprising one of a positive unity signal S2⁺ and a negative unity signal S2⁻ based on the absolute value of the high pass filtered error signal S1 being greater and less than or equal to than the non-linearity threshold value δ respectively.

6. The industrial plant system of claim 5, wherein the non-linearity threshold value δ is greater than zero and less than one.

7. The industrial plant system of claim 6, wherein the non-linearity threshold value δ is a programmable value selected from one of a set consisting of 0.005, 0.01, 0.02 and 0.25.

8. The industrial plant system of claim 5, wherein the trigger circuit further comprises:
an integrator configured to receive the transformed signal S2, integrate the transformed signal S2 over a time interval and generate an error duration signal S3.

9. The industrial plant system of claim 8, wherein the trigger circuit further comprises:
a second multiplier configured to receive the error duration signal S3, multiply the error duration signal S3 by a guard margin value Tₜₕ and generate a time limited error duration signal S4.

10. The industrial plant system of claim 9, wherein the trigger circuit further comprises:
a sign detector configured to receive the time limited error duration signal S4 and generate one of a positive unity pulse S5⁺ when the time limited error duration signal S4 is greater than zero and a negative unity pulse S5⁻ when the time limited error duration signal S4 is less than or equal to zero.

11. The industrial plant system of claim 10, wherein the sign detector is further configured to:
detect the steady state event of the error signal eᵢ(t) when a negative unity pulse S5⁻ transitions to a positive unity pulse S5⁺; and
transmit the positive unity pulse to a positive edge triggered circuit upon detecting the transition to the positive unity pulse S5⁺.

12. The industrial plant system of claim 11, wherein the trigger circuit further comprises:
a positive edge-triggered circuit connected to the sign detector, wherein the positive edge-triggered circuit is configured to generate the trigger pulse gᵢ(t) upon receiving the positive unity pulse S5⁺.

13. The industrial plant system of claim 12, wherein the trigger circuit further comprises:
a reset loop configured to transmit the trigger pulse gᵢ(t) to the integrator, wherein the trigger pulse is configured to reset the integrator to zero to avoid integrator wind-up.

14. A method for controlling an industrial plant system having N interconnected industrial processes, the method comprising:
establishing N actuators, each actuator operating to actuate one industrial process of the N interconnected industrial processes, each actuator being a control valve, an electrical actuator, or a piezoelectric actuator;
establishing N sensors, each sensor sensing an output signal from one industrial process of the N interconnected industrial processes;
establishing a decentralized controller including N error control loops, wherein each actuator of the N actuators is controlled by one corresponding error control loop of the N error control loops, so as to control one corresponding industrial process of the N interconnected industrial processes; and
for an i-th actuator, with i=1, 2, . . . , N, by a corresponding i-th error control loop, performing steady state error cancellation to generate a steady state control signal uᵢ(t) to control operation of the i-th actuator,
wherein the i-th error control loop further includes a first multiplier, an amplifier, a trigger circuit, a sample and hold circuit, and an adder, and
the step of performing steady state error cancellation further comprises:
by the first multiplier, obtaining a set point value Rᵢ assigned to the i-th actuator, acquiring an output signal Xᵢ(t) from an i-th sensor, which senses the output signal Xᵢ(t) from an i-th industrial process, and multiplying the set point value Rᵢ by a negative value of the output signal Xᵢ(t) to generate an error signal eᵢ(t),
by the amplifier connected to an output terminal of the first multiplier, amplifying the error signal eᵢ(t) by a gain Kᵢ and generating an amplified error control signal Kᵢ·eᵢ(t),
by the trigger circuit connected to the output terminal of the first multiplier, receiving the error signal eᵢ(t), detecting a steady state event of the error signal eᵢ(t), and generating a trigger pulse gᵢ(t) based on detecting the steady state event,
by the sample and hold circuit, receiving the trigger pulse gᵢ(t) from the trigger circuit, receiving the steady state control signal uᵢ(t) from the adder, generating a steady state error cancellation signal Z(t)ᵢ based on the trigger pulse gᵢ(t) and a negative value of the steady state control signal uᵢ(t), and injecting the steady state error cancellation signal Z(t)ᵢ into the adder, and
by the adder, adding the amplified error signals Kᵢ·eᵢ(t) and the steady state error cancellation signal Z(t)ᵢ to generate the steady state control signals uᵢ(t), and applying the steady state control signals uᵢ(t) to the i-th actuator to control operation thereof, such that the i-th actuator operates at an operating condition specified by the set point value Rᵢ.

15. The method of claim 14, wherein detecting the steady state event of the error signal by the trigger circuit further comprises:
by a high pass filter, receiving the error signal eᵢ(t) and generating a high pass filtered error signals S1, and
by a non-linearity detector, receiving the high pass filtered error signal S1, comparing an absolute value of the high pass filtered error signal S1 to a non-linearity threshold value δ and generate a transformed signal S2 comprising one of a positive unity signal S2⁺ and a negative unity signal S2⁻ based on the absolute value of the high pass filtered error signal S1 being greater and less than or equal to than the non-linearity threshold value δ respectively.

16. The method of claim 15, wherein detecting the steady state event of the error signal by the trigger circuit further comprises:
by an integrator, integrating the transformed signal S2 over a time interval and generating an error duration signal S3;
receiving, by a second multiplier, the error duration signal S3;
receiving, by the second multiplier, by a guard margin value Tₜₕ; and
multiplying, by the second multiplier, the error duration signal S3 by the guard margin value Tₜₕ and generating a time limited error duration signal S4.

17. The method of claim 16, wherein detecting the steady state event of the error signal eᵢ(t) by the trigger circuit further comprises:
receiving, by a sign detector, the time limited error duration signal S4;
generating, by the sign detector, one of a positive unity pulse S5⁺ when the time limited error duration signal S4 is greater than zero and a negative unity pulse S5⁻ when the time limited error duration signal S4 is less than or equal to zero;
detecting, by the sign detector, the steady state event of the error signal eᵢ(t) when a negative unity pulse S5⁻ transitions to a positive unity pulse S5⁺;
transmitting the positive unity pulse to a positive edge-triggered circuit upon detecting the transition to the positive unity pulse S5⁺; and
generating, by the positive edge-triggered circuit, the trigger pulse gᵢ(t) upon receiving the positive unity pulse S5⁺.

18. The method of claim 17, wherein detecting the steady state event of the error signals eᵢ(t) by the trigger circuit further comprises:
by a reset loop, transmitting the trigger pulse gᵢ(t) to the integrator, wherein the trigger pulse is configured to reset the integrator to zero to avoid integrator wind-up.

19. A non-transitory computer readable medium having instructions stored therein that, when executed by one or more processors, cause the one or more processors to perform a method for controlling an industrial plant system having N interconnected industrial processes, the industrial plant system further comprising N actuators and N sensors, each actuator operating to actuate one industrial process of the N interconnected industrial processes, each actuator being a control valve, an electrical actuator, or a piezoelectric actuator, each sensor sensing an output signal from one industrial process of the N interconnected industrial processes, the method comprising:
establishing a decentralized controller including N error control loops, wherein each actuator of the N actuators is controlled by one corresponding error control loop of the N error control loops; and
for an i-th actuator, with i=1, 2, . . . , N, by a corresponding i-th error control loop, performing steady state error cancellation to generate a steady state control signal u,(t) to control operation of the i-th actuator,
wherein the i-th error control loop further includes a first multiplier, an amplifier, a trigger circuit, a sample and hold circuit, and an adder, and
the step of performing steady state error cancellation further comprises:
by the first multiplier, obtaining a set point value Rᵢ assigned to the i-th actuator, acquiring an output signal Xᵢ(t) from an i-th sensor, which senses the output signal Xᵢ(t) from an i-th industrial process, and multiplying the set point value Rᵢ by a negative value of the output signal Xᵢ(t) to generate an error signal eᵢ(t),
by the amplifier connected to an output terminal of the first multiplier, amplifying the error signal eᵢ(t) by a gain Kᵢ and generating an amplified error control signal Kᵢ·eᵢ(t),
by the trigger circuit connected to the output terminal of the first multiplier, receiving the error signal eᵢ(t), detecting a steady state event of the error signal eᵢ(t), and generating a trigger pulse gᵢ(t) based on detecting the steady state event,
by the sample and hold circuit, receiving the trigger pulse gᵢ(t) from the trigger circuit, receiving the steady state control signal uᵢ(t) from the adder, generating a steady state error cancellation signal Z(t)ᵢ based on the trigger pulse gᵢ(t) and a negative value of the steady state control signal uᵢ(t), and injecting the steady state error cancellation signal Z(t)ᵢ into the adder, and
by the adder, adding the amplified error signals Kᵢ·eᵢ(t) and the steady state error cancellation signal Z(t)ᵢ to generate the steady state control signals uᵢ(t), and applying the steady state control signals uᵢ(t) to the i-th actuator to control operation thereof, such that the i-th actuator operates at an operating condition specified by the set point value Rᵢ.
